(19) United States
(12) Patent Application Publication
(10) Pub. No.: US 2018/0302641 A1
(43) Pub. Date: Oct. 18, 2018

(54) IMAGE PREDICTING DEVICE FOR IMAGE DECODING DEVICE OR IMAGE ENCODING DEVICE

(71) Applicant: Sharp Kabushiki Kaisha, Sakai City, Osaka (JP)

(72) Inventors: Tomohiro IKAI, Sakai City (JP); Takeshi TSUKUBA, Sakai City (JP)

(21) Appl. No.: 15/765,276

(22) PCT Filed: Aug. 26, 2016
(86) PCT No.: PCT/JP2016/075052

§ 371 Date: Apr. 2, 2018

(30) Foreign Application Priority Data
Oct. 5, 2015 (JP) 2015-197489

(51) Int. Cl. H04N 19/52; H04N 19/105; H04N 19/124; H04N 19/176; H04N 19/186

(52) U.S. Cl. CPC H04N 19/52; H04N 19/105; H04N 19/186; H04N 19/176; H04N 19/124

(57) ABSTRACT

An image predicting device for improving the accuracy of an intra LM predicted image or an illuminance predicted image is provided. The image predicting device includes a linear prediction parameter derivation section that derives linear prediction parameters a and b and a linear prediction section that generates a predicted image on the basis of the linear prediction parameters. The linear prediction parameter derivation section includes means for deriving the linear prediction parameter a from a first parameter a1 and a second parameter a2. The linear prediction parameter derivation section includes at least one of means for comparing the first parameter a1 with a predetermined threshold THN and, in a case where the first parameter a1 is less than the threshold THN or not greater than the threshold THN, subtracting a first cost a1costN from the first parameter a1 and means for comparing the first parameter a1 with a predetermined threshold THP and, in a case where the first parameter a1 is less than the threshold THP or not greater than the threshold THP, adding a second cost a1costP to the first parameter a1.

### TECHNICAL FIELD

The present invention relates to an image decoding device, an image encoding device, and a predicted image generation device.

### BACKGROUND ART

For efficient transmission or recording of a moving image, a moving image encoding device that generates coded data by coding a moving image and a moving image decoding device that generates a decoded image by decoding the coded data are used.

Specific examples of moving image coding schemes include schemes proposed by H.264/MPEG-4.AVC and HEVC (High-Efficiency Video Coding).

Under such a moving image coding scheme, an image (picture) constituting a moving image is managed by a hierarchical structure composed of slices into which the image is partitioned, coding units into which each of the slices is partitioned, and prediction units (PUs) and transform units (TUs) that are blocks into which each of the coding units is partitioned, and is coded/decoded for each block.

Further, under such a moving image coding scheme, normally, a predicted image is generated on the basis of a locally-decoded image obtained by coding/decoding an input image, and a prediction residual (also called “difference image” or “residual image”) obtained by subtracting the predicted image from the input image (original image) is coded. The predicted image can be generated, for example, by an inter-frame prediction (inter prediction) or an intra-frame prediction (intra prediction).

In the field of intra-frame predictions, NPL 1 discloses a method including estimating linear prediction parameters from a relationship between a luminance component and a chrominance component that have already been decoded and predicting a chrominance component of a target block with use of the linear prediction parameters thus estimated.

Furthermore, in the field of derivation of linear prediction parameters, NPL 2 and NPL 3 disclose techniques for stabilizing linear prediction parameters by adding regularization costs in addition to the method of least squares, by which square errors are minimized.

### CITATION LIST

### Non Patent Literature

NPL 1: J. Kim, S.-W. Park, J.-Y. Park, B.-M. Jeon (LG), “Intra chroma prediction using inter channel correlation”, JCTVC-B021, JCT-VC 2nd Meeting: Geneva, CH, 21-28 Jul. 2010
NPL 2: T. Ikai, “3D-CE5.h related: Illumination compensation regression improvement and simplification”, JCT3V-D0061, JCT3V 4th Meeting: Incheon, KR, 20-26 Apr. 2013 published on Apr. 12, 2013)
NPL 3: J. Chen, Y. Chen, M. Karczewicz, X. Li, H. Liu, L. Zhang, X. Zhao, “Coding tools investigation for next generation video coding”, ITU-T SG16 Doc. COM16-C806, February 2015.

### SUMMARY OF INVENTION

### Technical Problem

However, in NPL 1, which does not use such regularization costs as to stabilize linear prediction parameters, there has been such a problem that the linear prediction parameters thus derived are easily influenced by noise. In NPL 2, which uses regularization costs, there has been such a problem that the regularization costs are not always suited for an inter color component prediction by which to predict a color space (e.g. a chrominance from a luminance and a chrominance from another chrominance) where the parameter of a tilt of a linear prediction formula can be of either positive or negative sign. NPL 3, which discloses regularization costs that are used in a linear prediction in a case of predicting a chrominance from another chrominance, fails to give consideration to the sign or size of the parameter of the tilt of a linear prediction and, in particular, is undesirably not appropriate for a case where there may be the tilt is positive. Thus, in the field of predicted image generation devices that estimate inter color component linear prediction parameters and generate predicted images with use of the linear prediction parameters thus estimated, there has conventionally been such a problem that the linear prediction parameters thus estimated are easily influenced by noise. Furthermore, in particular, there has been such a problem that the prediction parameters thus estimated are not appropriate for a prediction between different color components in which the parameter of a tilt of a linear prediction formula can be of either positive or negative sign.

### Solution to Problem

According to an embodiment of the present invention, an image predicting device includes: a linear prediction parameter derivation section that, with an input being sets of pixel values xi and pixel values yi corresponding to an index i, derives linear prediction parameters a and b for predicting yi from xi; and a linear prediction section that generates a predicted image on the basis of the linear prediction parameters. The linear prediction parameter derivation section includes means for deriving the linear prediction parameter a from a first parameter a1 derived on the basis of the sum XY of the products of the pixel values xi and the pixel values yi and the product of the sum X of the pixel values xi and the sum Y of the pixel values yi and a second parameter a2 derived on the basis of the sum XX of the products of the pixel values xi and the pixel values xi and the product of the sum X of the pixel values xi and the sum X of the pixel values xi. The linear prediction parameter derivation section includes at least one of means for comparing the first parameter a1 with a predetermined threshold THN and, in a case where the first parameter a1 is less than the threshold THN or not greater than the threshold THN, subtracting a first cost a1costN from the first parameter a1 and means for comparing the first parameter a1 with a predetermined threshold THP and, in a case where the first parameter a1 is less than the threshold THP or not greater than the threshold THP, adding a second cost a1costP to the first parameter a1.

### Advantageous Effects of Invention

The present invention allows linear prediction parameters that are estimated to have resistance to noise, thus bringing about an improvement in the accuracy of a predicted image that is derived with use of the linear prediction parameters. Coding efficiency is improved in an image decoding device and an image encoding device that utilize linear predictions.

### BRIEF DESCRIPTION OF DRAWINGS

FIG. 1 is a block diagram showing a configuration of an LM prediction section 3093 according to the present embodiment.

FIG. 2 is a diagram showing a hierarchical structure of data of a coded stream according to the present embodiment.

FIG. 3 is a conceptual diagram showing an example of a reference picture list.

FIG. 4 is a conceptual diagram showing examples of reference pictures.

FIG. 5 is a schematic view showing a configuration of an image decoding device according to the present embodiment.

FIG. 6 is a schematic view showing a configuration of an inter prediction parameter decoding section according to the present embodiment.

FIG. 7 is a schematic view showing a configuration of a merge prediction parameter derivation section according to the present embodiment.

FIG. 8 is a schematic view showing a configuration of an AMVP prediction parameter derivation section according to the present embodiment.

FIG. 9 is a conceptual diagram showing examples of vector candidates.

FIG. 10 is a schematic view showing a configuration of an inter prediction parameter decoding control section according to the present embodiment.

FIG. 11 is a schematic view showing a configuration of an inter prediction image generation section according to the present embodiment.

FIG. 12 is a conceptual diagram of an LM prediction according to the present embodiment.

FIG. 13 is a conceptual diagram of illuminance compensation according to the present embodiment.

FIG. 14 is a block diagram showing a configuration of an image encoding device according to the present embodiment.

FIG. 15 is a schematic view showing a configuration of an inter prediction parameter coding section according to the present embodiment.

FIG. 16 is a diagram showing a table that is used in illuminance compensation according to the present embodiment.

FIG. 17 illustrates histograms showing distributions of a linear prediction parameter a according to the present embodiment.

FIG. 18 is a block diagram showing a configuration of an LM parameter a derivation section 309316 according to the present embodiment.

FIG. 19 is a block diagram showing a configuration of an LM regularization cost addition section 309318 according to the present embodiment.

FIG. 20 is a block diagram showing a configuration of the LM regularization cost addition section 309318 according to the present embodiment.

FIG. 21 is a flow chart showing an operation of an LM regularization cost addition section 309318A and an LM regularization cost addition section 309318A2 according to the present embodiment.

FIG. 22 is a flow chart showing an operation of an LM regularization cost addition section 309318B and an LM regularization cost addition section 309318B2 according to the present embodiment.

FIG. 23 is a flow chart showing an operation of an LM regularization cost addition section 309318C and an LM regularization cost addition section 309318C2 according to the present embodiment.

FIG. 24 is a block diagram showing a configuration of an illuminance compensation section 3093 according to the present embodiment.

FIG. 25 is a schematic view showing a configuration of an image transmission system according to an embodiment of the present invention.

### DESCRIPTION OF EMBODIMENTS

### First Embodiment

The following describes an embodiment of the present invention with reference to the drawings.

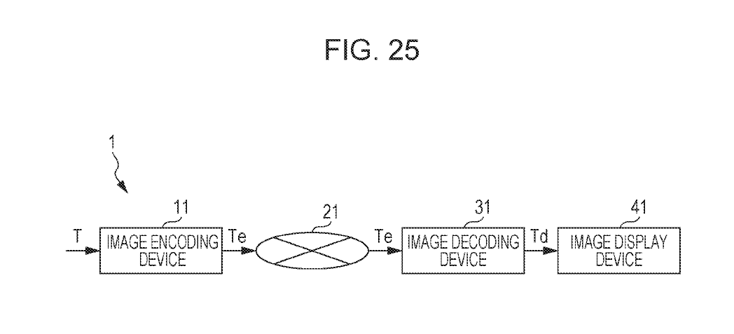

FIG. 25 is a schematic view showing a configuration of an image transmission system 1 according to the present embodiment.

The image transmission system 1 is a system that transmits codes into which a plurality of layer images have been coded and displays an image obtained by decoding the codes thus transmitted. The image transmission system 1 includes an image encoding device 11, a network 21, an image decoding device 31, and an image display device 41.

A signal T representing a single layer or a plurality of layer images is inputted to the image encoding device 11. A layer image is an image that is viewed or taken at a certain resolution and a certain viewpoint. In a case of performing view scalable coding, by which a three-dimensional image is coded with use of a plurality of layer images, each of the plurality of layer images is called “viewpoint image”. Further, in a case of performing spatial scalable coding, the plurality of layer images are composed of base layer images, which are low in resolution, and enhancement layer images, which are high in resolution. In a case of performing SNR scalable coding, the plurality of layer images are composed of base layer images, which are low in image quality, and enhancement layer images, which are high in image quality. It should be noted that the image encoding device 11 and the image decoding device 31 may use a single layer image or may perform any combination of view scalable coding, spatial scalable coding, and SNR scalable coding. The network 21 transmits, to the image decoding device 31, coded streams Te generated by the image encoding device 11. The network 21 is the internet, a wide area network (WAN), a local area network (LAN), or a combination thereof. The network 21 is not necessarily limited to a bidirectional communication network but may be a unidirectional or bidirectional communication network that transmits broadcast waves such as terrestrial digital broadcasts and satellite broadcasts. Further, the network 21 may be replaced by a storage medium such as a DVD (digital versatile disc) or a BD (blue-ray disc) storing the coded streams Te.

The image decoding device 31 generates a plurality of decoded layer images Td (decoded viewpoint images Td) by decoding the coded streams Te transmitted by the network 21, respectively.

The image display device 41 displays all or some of the plurality of decoded layer images Td generated by the image decoding device 31. For example, in view scalable coding, in a case where all of the plurality of decoded layer images Td are displayed, a three-dimensional image (stereoscopic image) or a free viewpoint image is displayed, and in a case where some of the plurality of decoded layer images Td are displayed, a two-dimensional image is displayed. The image display device 41 includes a display device such as a liquid crystal display or an organic EL (electroluminescence) display. Further, in spatial scalable coding or SNR scalable coding, in a case where the image decoding device 31 and the image display device 41 have high processing capability, enhancement layer images, which are high in image quality, are displayed, and in a case where the image decoding device 31 and the image display device 41 have only lower processing capability, base layer images, which do not require as high display capability as enhancement layers, are displayed.

<Structure of Coded Stream Te>

Prior to a detailed description of the image encoding device 11 and the image decoding device 31 according to the present embodiment, a description is given of a data structure of a coded stream Te that is generated by the image encoding device 11 and decoded by the image decoding device 31.

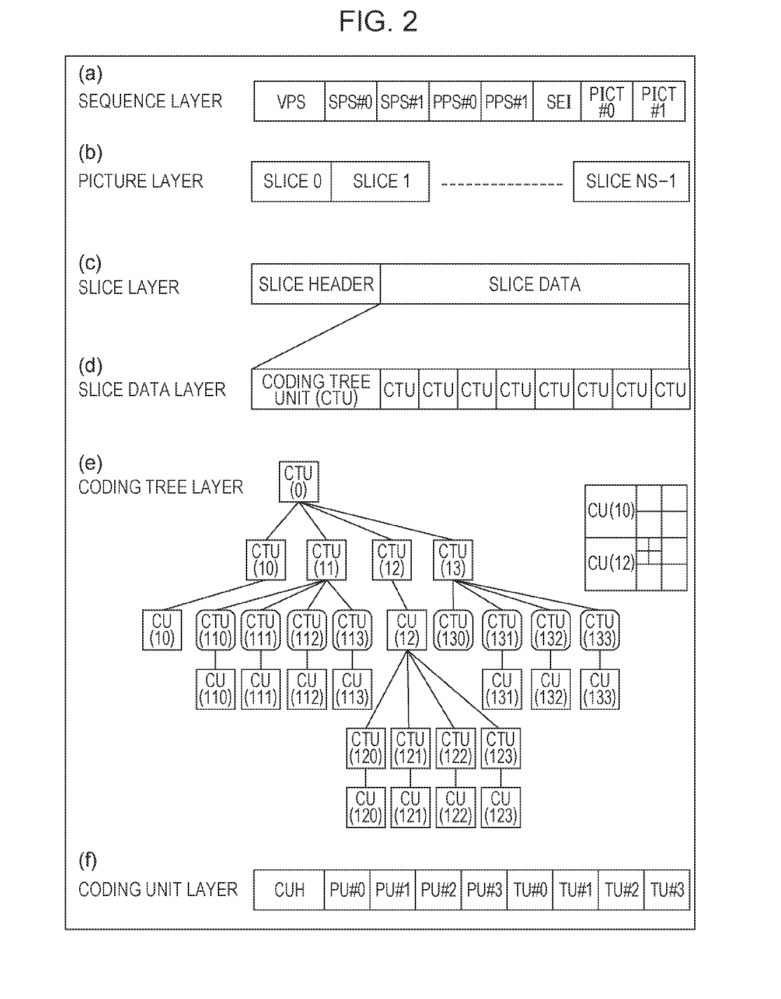

FIG. 2 is a diagram showing a hierarchical structure of data in a coded stream Te. The coded stream Te illustratively includes a sequence and a plurality of pictures constituting the sequence. (a) to (f) of FIG. 2 are diagrams showing a sequence layer defining a sequence SEQ, a picture layer defining a picture PICT, a slice layer defining a slice S, a slice data layer defining slice data, a coding tree layer defining coding tree units included in the slice data, and a coding unit layer defining coding units (CUs) included in a coding tree, respectively.

(Sequence Layer)

The sequence layer defines an aggregate of data that the image decoding device 31 refers to in order to decode the sequence SEQ to be processed (hereinafter also referred to as “target sequence”). As shown in (a) of FIG. 2, the sequence SEQ includes a vide parameter set, a sequence parameter set SPS, a picture parameter set PPS, a picture PICT, and supplemental enhancement information SEI. Note here that a value immediately following # indicates a layer ID. Although FIG. 2 shows an example in which there are #0 and #1, i.e. layer 0 and layer 1, of coded data, this is not intended to limit the types of layers or the number of layers.

The video parameter set VPS defines an aggregate of coding parameters that are common to a plurality of moving images each composed of a plurality of layers and an aggregate of coding parameters associated with the plurality of layers included in the moving images and the individual layers.

The sequence parameter set SPS defines an aggregate of coding parameters to which the image decoding device 31 refers to in order to decode the target sequence. For example, the sequence parameter set SPS defines the width and height of a picture.

The picture parameter set PPS defines an aggregate of coding parameters that the image decoding device 31 refers to in order to decode each picture in the target sequence. Examples include a reference value of quantization width (pic_init_qp_minus26) that is used for decoding a picture and a flag (weighted_pred_flag) indicating the application of a weighted prediction. It should be noted that there may be a plurality of the PPSs. In that case, any of the plurality of PPSs is selected from each picture in the target sequence.

(Picture Layer)

The picture layer defines an aggregate of data to which the image decoding device 31 refers to in order to decode the picture PICT to be processed (hereinafter also referred to as “target picture”). As shown in (b) of FIG. 2, the picture PICT includes slices S0 to SNS−1 (where NS is the total number of slices that are included in the picture PICT).

It should be noted that in a case where it is not necessary to make distinctions among the slices S0 to SNS−1, they may be described with omission of the suffixes immediately following the reference signs. Further, the same applies to other pieces of data included in the coded stream Te to be described below to which suffixes are added.

(Slice Layer)

The slice layer defines an aggregate of data that the image decoding device 31 refers to in order to decode the slice S to be processed (also referred to as “target slice”). As shown in (c) of FIG. 2, the slice S includes a slice header SH and slice data SDATA.

The slice header SH includes a group of coding parameters that the image decoding device 31 refers to in order to decide how to decode the target slice. Slice type information (slice_type) designating a slice type is an example of a coding parameter that is included in the slice header SH.

Examples of slice types that can be designated by the slice type information include (1) an I slice, which is coded with use of an intra prediction alone, (2) a P slice, which is coded with use of a unidirectional prediction or an intra prediction, and (3) a B slice, which is coded with use of a unidirectional prediction, a bidirectional prediction, or an intra prediction.

It should be noted that the slice header SH may include reference (pic_parameter_set_id) to the picture parameter set PPS that is included in the sequence layer.

(Slice Data Layer)

The slice data layer defines an aggregate of data to which the image decoding device 31 refers to in order to decode the slice data SDATA to be processed. As shown in (d) of FIG. 2, the slice data SDATA includes coding tree blocks (CTBs). The CTBs are blocks of fixed size (e.g. 64×64) constituting a slice and are sometimes also called “largest coding units (LCUs)”.

(Coding Tree Layer)

As shown in (e) of FIG. 2, the coding tree layer defines an aggregate of data that the image decoding device 31 refers to in order to decode the coding tree block to be processed. The coding tree unit is partitioned by reflexive quadtree partitioning. Tree structure nodes that are obtained by reflexive quadtree partitioning are referred to as “coding trees”. A quadtree intermediate node is a coding tree unit (CTU), and the coding tree block per se is also defined as the most significant CTU. The CTU includes a split flag (splif_flag) and, in a case where splif_flag is 1, is partitioned into four coding tree units CTU. In a case where splif_flag is 0, the coding tree unit CTU is partitioned into four coding units (CUs). The coding units CU are terminal nodes of the coding tree layer and are not further partitioned in this layer. The coding units CU serve as basic units of a coding process.

Further, in a case where the size of the coding tree block CTB is 64×64 pixels, the size of each of the coding units may be 64×64 pixels, 32×32 pixels, 16×16 pixels, or 8×8 pixels.

(Coding Unit Layer)

As shown in (f) of FIG. 2, the coding unit layer defines an aggregate of data that the image decoding device 31 refers to in order to decode the coding unit to be processed. Specifically, the coding unit is composed of a CU header CUH, a prediction tree, a transform tree, and a CU header CUF. The CU header CUH defines whether the coding unit is a unit that involves the use of an intra prediction or a unit that involves the use of an inter prediction. The coding unit serves as a route for the prediction tree (PT) and the transform tree (TT). The CU header CUF is included either between the prediction tree and the transform tree or after the transform tree.

The prediction tree, whose coding unit is partitioned into one or more prediction blocks, defines the position and size of each prediction block. Put differently, the prediction block is one or more non-overlap regions constituting a coding unit. Further, the prediction tree includes one or more prediction blocks obtained by the aforementioned partitioning.

A prediction process is performed for each of these prediction blocks. A prediction block serving as a unit of prediction is hereinafter also referred to as “prediction unit (PU)”.

Broadly speaking, there are two types of partitioning in the prediction tree: the case of an intra prediction and the case of an inter prediction. An intra prediction is a prediction within the same picture, and an inter prediction refers to a prediction process that is performed between pictures (e.g. between display times or between layer images) that are different from each other.

In the case of an intra prediction, the partitioning method is either 2N×2N (same size as the coding unit) or N×N.

Further, in the case of an inter prediction, the partitioning method is coded by part_mode of coded data and examples include 2N×2N (same size as the coding unit), 2N×N, 2N×nU, 2N×nD, N×2N, nL×2N, nR×2N, and N×N. It should be noted that 2N×nU indicates that the coding unit of 2N×2N is partitioned into two regions of 2N×0.5N and 2N×1.5N starting from the top. 2N×nD indicates that the coding unit of 2N×2N is partitioned into two regions of 2N×1.5N and 2N×0.5N starting from the top. nL×2N indicates that the coding unit of 2N×2N is partitioned into two regions of 0.5N×2N and 1.5N×2N starting from the left. nR×2N indicates that the coding unit of 2N×2N is partitioned into two regions of 1.5N×2N and 0.5N×1.5N starting from the left. Since the number of partitions is 1, 2, or 4, the CU includes one to four PUs. These PUs are expressed as PU0, PU1, PU2, and PU3 in sequence.

Further, the transform tree, whose coding unit is divided into one or more transform blocks, defines the position and size of each transform block. Put differently, the transform block is one or more non-overlap regions constituting a coding unit. Further, the transform tree includes one or more transform blocks obtained by the aforementioned partitioning.

Partitioning in the transform tree includes the allocation of a region of the same size as the coding unit as a transform block and, as in the case of the aforementioned tree block partitioning, reflexive quadtree partitioning.

A transform process is performed for each of these transform blocks. A transform block serving as a unit of transform is hereinafter also referred to as “transform unit (TU)”.

(Prediction Parameter)

A predicted image of a prediction unit is derived by a prediction parameter attached to the prediction unit. Prediction parameters include either a prediction parameter of intra prediction or a prediction parameter of inter prediction. The following describes a prediction parameter of inter prediction (inter prediction parameter). An inter prediction parameter is composed of prediction list utilization flags predFlagL0 and predFlagL1, reference picture indices refIdxL0 and refIdxL1, and vectors mvL0 and mvL1. The prediction list utilization flags predFlagL0 and predFlagL1 are flags that indicate whether reference picture lists called “L0 list” and “L1 list” are used, respectively, and a reference picture list corresponding to the case where the value is 1 is used. It should be noted that in the case of the phrase “flag indicating whether it is XX” herein, 1 represents a case where it is XX and 0 represents a case where it is not XX, and logical NOT, logical AND, and the like treat 1 as true and 0 as false (same applies below). Note, however, that other values may be used as a true value and a false value in an actual device or method. A case where two reference picture lists are used, i.e. a case where predFlagL0=1 and predFlagL1=1, corresponds to a bi-prediction, and a case where one reference picture list is used, i.e. a case where (predFlagL0, predFlagL1)=(1, 0) or (predFlagL0, predFlagL1)=(0, 1), corresponds to a uni-prediction. It should be noted that information on the prediction list utilization flags can also be expressed by the after-mentioned inter prediction flag inter_pred_idc. Normally, the prediction list utilization flags are used in the after-mentioned predicted image generation sections and prediction parameter memories, and in a case where information as to which reference picture list is used is decoded from coded data, the inter-prediction flag inter_pred_idc is used.

Examples of syntax elements for deriving an inter prediction parameter included in coded data include a partition mode part_mode, a merge flag merge_flag, a merge index merge_idx, an inter prediction flag inter_pred_idc, a reference picture index refIdxLX, a prediction vector index mvp_LX_idx, and a difference vector mvdLX.

(Example of Reference Picture List)

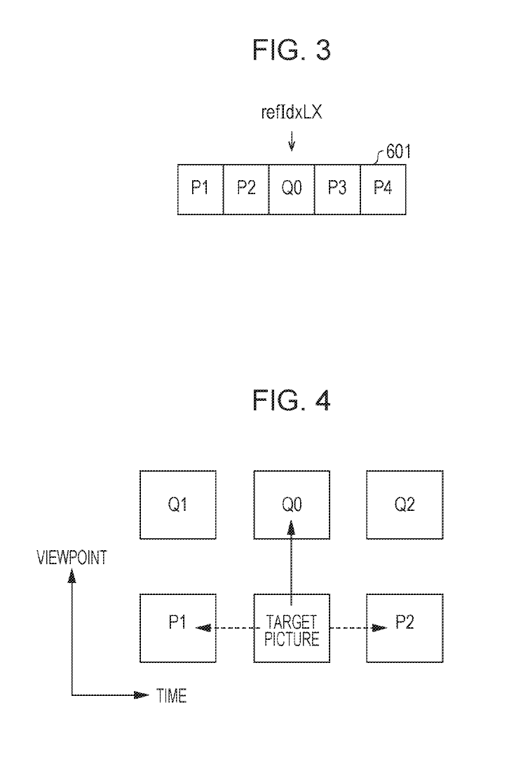

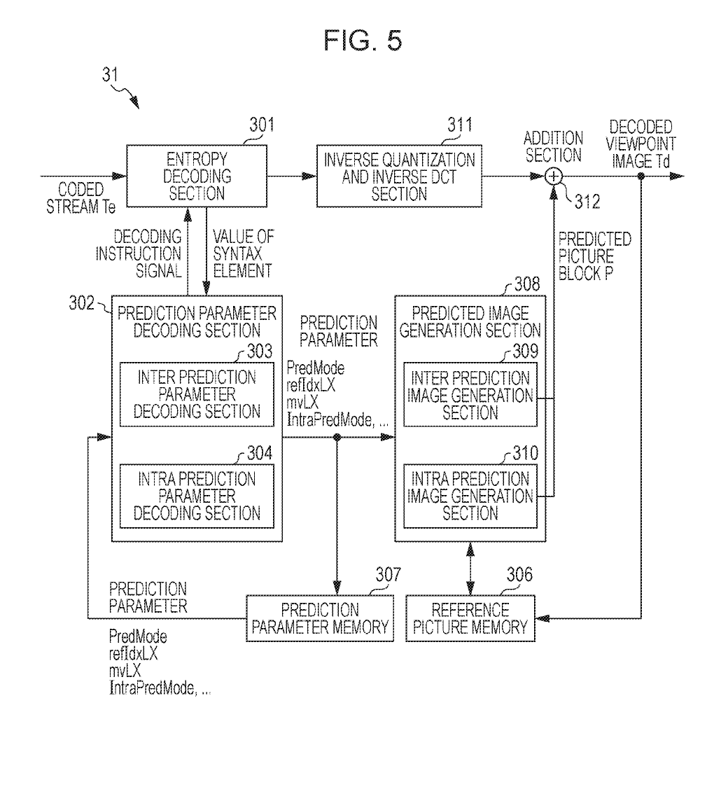

Next, an example of a reference picture list is described. A reference picture list is a row of reference pictures stored in a reference picture memory 306 (FIG. 5). FIG. 3 is a conceptual diagram showing an example of a reference picture list. In a reference picture list 601, the five rectangles arranged in a row from side to side indicate reference pictures, respectively. The reference signs P1, P2, Q0, P3, and P4, which are shown in sequence from the left edge to the right, are reference signs that indicate the respective reference pictures. “P” of P1 or the like indicates a viewpoint P, and “Q” of Q0 indicates a viewpoint Q that is different from the viewpoint P. The suffixes added to the P's and Q indicate picture order counts POC. The downward arrow directly below refIdxLX indicates that the reference picture index refIdxLX is an index that refers to the reference picture Q0 in the reference picture memory 306.

(Examples of Reference Pictures)

Next, examples of reference pictures that are used in deriving a vector are described. FIG. 4 is a conceptual diagram showing examples of reference pictures. In FIG. 4, the horizontal axis represents display time, and the vertical axis represents viewpoint. The two rows and three columns of (total of six) rectangles shown in FIG. 4 indicate pictures, respectively. Of the six rectangles, the second rectangle from the left in the lower row indicates a picture (target picture) and the remaining five rectangles indicate reference pictures, respectively. The reference picture Q0, which is indicated by an upward arrow from the target picture, is a picture that is identical in display time to but different in viewpoint from the target picture. In a disparity prediction based on the target picture, the reference picture Q0 is used. The reference picture P1, which is indicated by a leftward arrow from the target picture, is a past picture that is identical in viewpoint to the target picture. The reference picture P2, which is indicated by a rightward arrow from the target picture, is a future picture that is identical in viewpoint to the target picture. In a motion prediction based on the target picture, the reference picture P1 or P2 is used.

(Inter Prediction Flag and Prediction List Utilization Flags)

Relationships between the inter prediction flag and the prediction list utilization flags predFlagL0 and predFlagL1 are interconvertible as indicated below. Therefore, as an inter prediction parameter, the prediction list utilization flags or the inter prediction flag may be used. Further, in the following, a determination based on the prediction list utilization flags is possible even when the prediction list utilization flags are replaced by the inter prediction flag. On the other hand, a determination based on the inter prediction flag is possible even when the inter prediction flag is replaced by the prediction list utilization flags.

Inter prediction flag=(predFlagL1<<1)+predFlagL0

predFlagL0=Inter prediction flag & 1

predFlagL1=Inter prediction flag>>1,

where >> is a right shift and << is a left shift.

(Merge Prediction and AMVP Prediction)

Methods for decoding (coding) a prediction parameter include a merge prediction (merge) mode and an AMVP (adaptive motion vector prediction) mode. The merge flag merge_flag is a flag for differentiating between these modes. Whether in the merge prediction mode or in the AMVP mode, the prediction parameter of the target PU is derived with use of the prediction parameter of an already-processed block. The merge prediction mode is a mode in which an already-derived prediction parameter is directly used without the coded data including a prediction list utilization flag predFlagLX (inter prediction flag inter_pred_idc), a reference picture index refIdxLX, and a vector mvLX, and the AMVP mode is a mode in which coded data includes an inter prediction flag inter_pred_idc, a reference picture index refIdxLX, and a vector mvLX. It should be noted that the vector mvLX is coded as the prediction vector index mvp_LX_idx, which indicates a prediction vector, and the difference vector (mvdLX).

The inter prediction flag inter_pred_idc is data that indicates the types and number of reference pictures and takes on any of the values Pred_L0, Pred_L1, and Pred_Bi. Pred_L0 and Pred_L1 indicate that reference pictures stored in the reference picture lists called “L0 list” and “L1 list” are used, respectively, and both indicate that one reference picture is used (uni-prediction). A prediction based on the L0 list and a prediction based on the L1 list are called “L0 prediction” and “L1 prediction”, respectively. Pred_Bi indicates that two reference pictures are used (bi-prediction) and indicates that two of the reference pictures stored in the L0 list and the L1 list are used. The prediction vector index mvp_LX_idx is an index that indicates a prediction vector, and the reference picture index refIdxLX is an index that indicates a reference picture stored in a reference picture list. It should be noted that LX is a description method that is used in a case where no distinction is made between an L0 prediction and an L1 prediction, and a distinction is made between a parameter for the L0 list and a parameter for the L1 list by replacing LX with L0 or L1. For example, refIdxL0 is a reference picture index that is used for an L0 prediction, refIdxL1 is a reference picture index that is used for an L1 prediction, and refIdx (refIdxLX) is a symbol that is used in a case where no distinction is made between refIdxL0 and refIdxL1.

The merge index merge_idx is an index that indicates which prediction parameter of prediction parameter candidates (merge candidates) derived from a block finished with a process is used as a prediction parameter of the decoding target block.

(Motion Vector and Disparity Vector)

Vectors mvLX include a motion vector and a disparity vector (parallax vector). A motion vector is a vector that indicates a position gap between the position of a block in a picture at a display time at which a certain layer is present and the position of a corresponding block in a picture of the same layer at a different display time (e.g. a neighboring discrete time). A disparity vector is a vector that indicates a position gap between the position of a block in a picture at a display time at which a certain layer is present and the position of a corresponding block in a picture of a different layer at the same display time. Examples of pictures of different layers are pictures of different viewpoints, pictures of different resolutions, or the like. In particular, a disparity vector corresponding to pictures of different viewpoints is called “parallax vector”. In the following description, in a case where no distinction is made between a motion vector and a disparity vector, they are simply called “vectors mvLX”. A prediction vector and a difference vector pertaining to a vector mvLX are called “prediction vector mvpLX” and “difference vector mvdLX”, respectively. Whether the vector mvLX and the difference vector mvdLX are motion vectors or disparity vectors is determined with use of the reference picture index refIdxLX attached to the vectors.

(Configuration of Image Decoding Device)

Next, a configuration of the image decoding device 31 according to the present embodiment is described. FIG. 5 is a schematic view showing the configuration of the image decoding device 31 according to the present embodiment. The image decoding device 31 includes an entropy decoding section 301, a prediction parameter decoding section 302, a reference picture memory (reference image storage section, frame memory) 306, a prediction parameter memory (prediction parameter storage section, frame memory) 307, a predicted image generation section 308, an inverse quantization and inverse DCT section 311, an addition section 312, and a residual storage section 313 (residual recording section).

Further, the prediction parameter decoding section 302 includes an inter prediction parameter decoding section 303 and an intra prediction parameter decoding section 304. The predicted image generation section 308 includes an inter prediction image generation section 309 and an intra prediction image generation section 310.

The entropy decoding section 301 performs entropy decoding on a coded stream Te inputted from an outside source, separates individual codes (syntax elements), and decodes the codes. The codes thus separated include prediction information for generating a predicted image, residual information for generating a difference image, and the like.

The entropy decoding section 301 outputs some of the codes thus separated to the prediction parameter decoding section 302. Some of the codes thus separated include, for example, a prediction mode PredMode, a partition mode part_mode, a merge flag merge_flag, a merge index merge_idx, an inter prediction flag inter_pred_idc, a reference picture index refIdxLX, a prediction vector index mvp_LX_idx, and a difference vector mvdLX. Control as to which codes to decode is exercised on the basis of an instruction from the prediction parameter decoding section 302. The entropy decoding section 301 outputs a quantized coefficient to the inverse quantization and inverse DCT section 311. This quantized coefficient is a coefficient that is obtained by quantizing a residual signal by performing DCT (discrete cosine transform) on the residual signal in a coding process.

On the basis of the codes inputted from the entropy decoding section 301, the inter prediction parameter decoding section 303 decodes inter prediction parameters with reference to prediction parameters stored in the prediction parameter memory 307.

The inter prediction parameter decoding section 303 outputs the inter prediction parameters thus decoded to the predicted image generation section 308 and stores the inter prediction parameters thus decoded in the prediction parameter memory 307. The inter prediction parameter decoding section 303 will be described in detail later.

On the basis of the codes inputted from the entropy decoding section 301, the intra prediction parameter decoding section 304 decodes intra prediction parameters with reference to the prediction parameters stored in the prediction parameter memory 307. The intra prediction parameters are parameters that are used in a process of predicting a picture block within one picture, e.g. an intra prediction mode IntraPredMode. The intra prediction parameter decoding section 304 outputs the intra prediction parameters thus decoded to the predicted image generation section 308 and stores the intra prediction parameters thus decoded in the prediction parameter memory 307.

The intra prediction parameter decoding section 304 may derive different intra prediction modes for luminance and chrominance. In this case, the intra prediction parameter decoding section 304 decodes a luminance prediction mode IntraPredModeY as a prediction parameter of luminance and a chrominance prediction mode IntraPredModeC as a prediction parameter of chrominance. The luminance prediction mode IntraPredModeY is a 35 mode to which a planar prediction (0), a DC prediction (1), and directional predictions (2-34) correspond. The chrominance prediction mode IntraPredModeC involves the use of any of the planar prediction (0), the DC prediction (1), the directional predictions (2-34), and an LM mode (35). The intra prediction parameter decoding section 304 may decode a flag indicating whether IntraPredModeC is the same mode as a luminance mode. If the flag indicates that IntraPredModeC is the same mode as the luminance mode, the intra prediction parameter decoding section 304 may assign IntraPredModeY to IntraPredModeC, and if the flag indicates that IntraPredModeC is a different mode from the luminance mode, the intra prediction parameter decoding section 304 may decode the planar prediction (0), the DC prediction (1), the directional predictions (2-34), and the LM mode (35) as I IntraPredModeC.

The reference picture memory 306 stores, in a location determined in advance for each picture and block to be decoded, a block (reference picture block) of a reference picture generated by the addition section 312.

The prediction parameter memory 307 stores the prediction parameters in a location determined in advance for each picture and block to be decoded. Specifically, the prediction parameter memory 307 stores the inter prediction parameters decoded by the inter prediction parameter decoding section 303, the intra prediction parameters decoded by the intra prediction parameter decoding section 304, and the prediction mode predMode separated by the entropy decoding section 301. Examples of the inter prediction parameters to be stored include a prediction utilization flag predFlagLX (inter prediction flag inter_pred_idc), a reference picture index refIdxLX, and a vector mvLX.

The predicted image generation section 308 receives the prediction mode predMode inputted from the entropy decoding section 301 and also receives the prediction parameters from the prediction parameter decoding section 302. Further, the predicted image generation section 308 reads out a reference picture from the reference picture memory 306. In a prediction mode indicated by the prediction mode predMode, the predicted image generation section 308 generates a predicted picture block P (predicted image) with use of the prediction parameters thus received and the reference picture thus read out.

Note here that in a case where the prediction mode predMode indicates an inter prediction mode, the inter prediction image generation section 309 generates the predicted picture block P according to an inter prediction with use of the inter prediction parameters inputted from the inter prediction parameter decoding section 303 and the reference picture thus read out. A predicted picture block P corresponds to a prediction unit PU. The PU is equivalent to a portion of a picture composed of a plurality of pixels serving as a unit on which a prediction process is performed as mentioned above, i.e. to the decoding target block on which the prediction process is performed at once.

With respect to a reference picture list (L0 list or L1 list) whose prediction list utilization flag predFlagLX is 1, the inter prediction image generation section 309 reads out from the reference picture memory 306 a reference picture block located in a position indicated by the vector mvLX with the decoding target block used as a benchmark, from a reference picture indicated by the reference picture index refIdxLX. The inter prediction image generation section 309 generates a predicted picture block P by making a prediction for the reference picture block thus read out. The inter prediction image generation section 309 outputs the predicted picture block P thus generated to the addition section 312.

In a case where the prediction mode predMode indicates an intra prediction mode, the intra prediction image generation section 310 makes an intra prediction with use of the intra prediction parameters inputted from the intra prediction parameter decoding section 304 and the reference picture thus read out. Specifically, the intra prediction image generation section 310 reads out from the reference picture memory 306 a reference picture block located in a predetermined range from the decoding target block among already-decoded blocks of the picture to be decoded. The predetermined range is for example any of the left, upper left, upper, and upper right neighboring blocks in a case where the decoding target block moves in sequence in an order of so-called raster scanning, and varies depending on the intra prediction mode. The order of raster scanning is an order of sequential movement from the left edge to the right edge for each row from the upper edge to the lower edge of each picture.

The intra prediction image generation section 310 generates a predicted picture block by making a prediction in a prediction mode indicated by the intra prediction mode IntraPredMode for the reference picture block thus read out. The intra prediction image generation section 310 outputs the predicted picture block P thus generated to the addition section 312.

In a case where the intra prediction parameter decoding section 304 derives different intra prediction modes for luminance and chrominance, the intra prediction image generation section 310 generates a predicted picture block of luminance according to any of the planar prediction (0), the DC prediction (1), and the directional predictions (2-344) depending on the luminance prediction mode IntraPredModeY and generates a predicted picture block of chrominance according to any of the planar prediction (0), the DC prediction (1), the directional predictions (2-34), and the LM mode (35) depending on the chrominance prediction mode IntraPredModeC. An LM mode that involves the use of regularization costs is described here. A regularization cost is a term that is added as a parameter cost to an objective function in the derivation of a prediction parameter by the method of least squares. The LM mode includes: (TYPE 0), which derives, with use of a processed image neighboring a target block, linear prediction parameters for predicting a pixel value of chrominance from a pixel value of luminance and generates a picture block of chrominance from a processed block of luminance on the basis of the linear prediction parameters; and (TYPE 1), which derives, with use of a processed image neighboring a target block, linear prediction parameters for predicting a pixel value of chrominance from another pixel value of chrominance and generates another picture block of chrominance from a processed block of chrominance on the basis of the linear prediction parameters. Such a prediction by which to derive linear prediction parameters for estimating a color component from another color component and generate a predicted image with use of the linear prediction parameters thus derived is called “LM prediction”. The method of prediction is schematically the same as that which is performed by the after-mentioned illuminance compensation section 3093. The intra prediction image generation section 310 includes a DC prediction section 3101 (not illustrated), a planar prediction section 3102 (not illustrated), a directional prediction section 3103 (not illustrated), and an LM prediction section 3104 (not illustrated). It should be noted that “LM” of the term “LM prediction” is the abbreviation of “Liner Model”.

(Method of Least Squares and Regularization Term)

With respect to a two-dimensional progression (xi, yi) consisting of input reference signals xi and objective reference signals yi, where i=0 to N−1 (N is the number of progressions), thought is given to the following linear prediction formula for predicting the objective reference signals yi from the input reference signals xi. It should be noted that yi is also called “teacher signal”.

yi=a*xi+b

At this time, the sum E of square errors of linear prediction is defined by the following formula.

E=|yi−a*xi−b|̂2 Formula (E-1)

The linear prediction parameters a and b for minimizing the square error E are derived in the following manner, as the formula obtained by partially differentiating E by a and b is set 0.

a=(Σxy−N*ΣxΣy)/(Σxx−NΣxΣx)

b=(Σy/N−a*Σx/N) Formula (A-1)

However, in the derivation of a parameter by the method of least squares, the incorporation of noise components or the like in the reference signals xi and yi may make it impossible to estimate highly accurate linear prediction parameters a and b, unless a sufficient number N of reference signals are prepared. Further, in a case where N is small or in a case where changes in input reference pixels xi and objective reference pixels yi included in reference signals are small, there is a possibility of overfitting. Therefore, it is known that in a case of estimating linear prediction parameters, such a scheme is used as to derive the linear prediction parameters in consideration of costs incurred by adding appropriate parameter costs (regularization costs) to the error E. A generally known form of a regularization term is such regularization costs that the values of the parameters approximate to 0, i.e. a form obtained by multiplying the squared terms of a and b by weights lambda_a and lambda_b, respectively, as indicated by the following formula (ridge regression).

E=|yi−a*xi−b|̂2+lambda_a*â2+lambda_b*b̂2 Formula (E-2)

However, even when the regularization term of ridge regression is applied to an image, linear regression between pixels cannot build up the hypothesis per se that the linear prediction parameters a and b take on values that are close to 0, thus making it impossible to obtain appropriate results.

The inventors found that, in the case of application to an image, it is appropriate to examine the distributions and characteristics of the parameters a and b and use such a regularization term (i.e. a term that is proportional to the square of a gap between the parameter a and k) as to bring the parameter a close to an appropriate value k as indicated below.

E′=|yi−a*xi−b|̂2+lambda_a*(a−k)̂2 Formula (E-3)

The foregoing formula can be solved when the formula obtained by partially differentiating the sum E′ of square errors by a and b is set 0. This gives the following estimated formulae of the linear parameters a and b.

a=(Σxy−N*ΣxΣy−k*lambda_a)/(Σxx−NΣxΣx−lambda_a)

b=(Σy/N−a*Σx/N) Formula (A-3)

In the following, in a formula of division for deriving the linear prediction parameter a, the value equivalent to the numerator is called “first parameter a1 (numerator), and the number equivalent to the denominator is called “second parameter a2 (denominator)”. Note here that, assuming that Σxy−N*ΣxΣy=a1, Σxx−NΣxΣx=a2, and lambda_a=acost, the formula (A-1) of the method of least squares can be transformed in the following manner.

a=a1/a2

Furthermore, the formula (A-3) including the regularization term is transformed in the following manner.

a=(a1+k*acost)/(a2+acost)

The foregoing shows that, in the derivation of the linear prediction parameter a indicated by the division of the first parameter a1 by the second parameter a2, the linear prediction parameter a is obtained in consideration of the regularization term by updating the first parameter a1 by adding k*cost thereto and updating the second parameter a2 by adding acost thereto. In the following, values such as acost and k*acost that are used for updating the first parameter a1 and the second parameter a2 are herein called “regularization costs (or parameter costs)”.

(LM Prediction Section 3104)

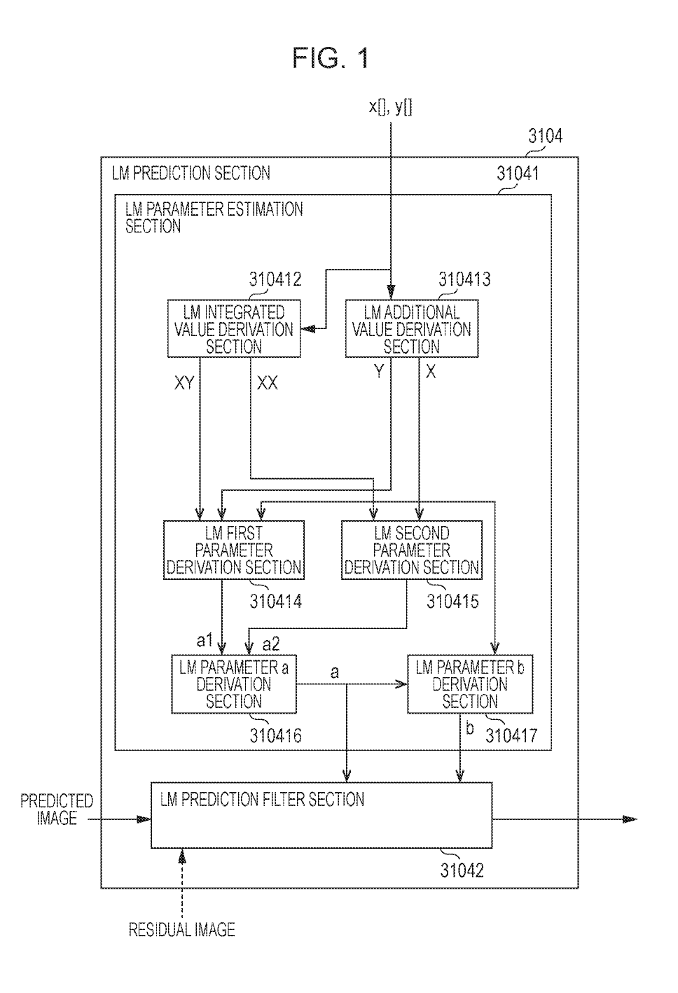

FIG. 1 is a block diagram showing a configuration of the LM prediction section 3104. The LM prediction section 3104 includes an LM parameter estimation section 31041 that derives linear prediction parameters and an LM prediction filter section 31042 that makes an actual prediction with use of the linear prediction parameters thus derived. The LM parameter estimation section 31041 includes an LM integrated value derivation section 310412, an LM additional value derivation section 310413, an LM first parameter derivation section 310414, an LM second parameter derivation section 310415, an LM parameter a derivation section 310416, and an LM parameter b derivation section 310417.

The LM parameter estimation section 31041 derives the linear prediction parameters a and b in a case of predicting the objective reference pixels yi from the input reference pixels xi according to the formula yi=a*xi+b. The linear prediction parameter a is equivalent to a slope, and the linear prediction parameter b is equivalent to an offset.

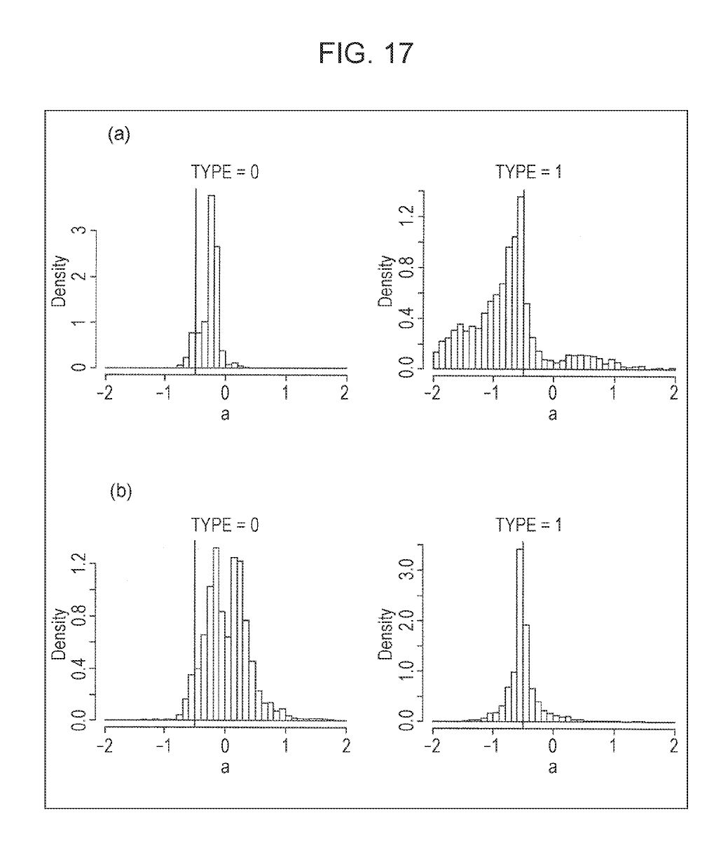

FIG. 17 illustrates histograms showing distributions of the linear prediction parameter a as estimated by the LM parameter estimation section 31041. (a) and (b) of FIG. 17 are distributions obtained from separate pictures. Although distributions of the parameter a vary from picture (sequence) to picture (sequence), the absolute value of a is comparatively mostly distributed in the range of 0 to 1. In TYPE=0, which corresponds to a color component prediction between a luminance and a chrominance, the parameter a is present both positively and negatively, and in TYYPE=1, which corresponds to a color component prediction between a chrominance and another chrominance, the parameter a is comparatively often negative but there also occurs a case where the parameter a is positive.

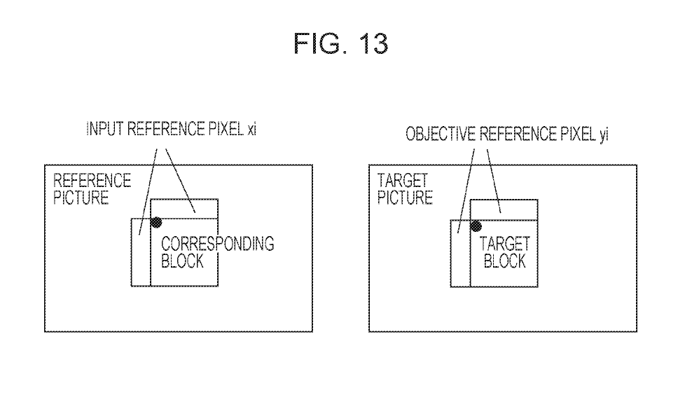

With the input reference pixels x[ ] being pixels present around a reference block of a color component around the target block shown in FIG. 12 and the objective reference pixels y[ ] being pixels of another color component present around the target block, the LM parameter estimation section 31041 derives the parameters a and b, which are parameters in a case of linearly predicting the objective reference pixels y[ ] from the input reference pixels x[ ], on the basis of the input reference pixels x[ ] and the objective reference pixels y[ ].

The LM additional value derivation section 310413 derives the sum Y of objective reference pixels y and the sum X of input reference pixels x according to the following Formulae (B-2) and (B-3).

The LM integrated value derivation section 310412 derives the sum XY of the products of the objective reference pixels y and the input reference pixels x and the sum XX of the squares of the objective reference pixels x according to the following Formulae (B-4) and (B-5).

X=Σx[i] Formula (B-2)

Y=Σy[i] Formula (B-3)

XX=Σ(x[i]*x[i]) Formula (B-4)

XY=Σ(y[i]*y[i]) Formula (B-5)

Note here that Σ is the sum with respect to a reference region and a sum with respect to an index i specifying pixels of the reference region is derived. That is, Σ(z[i]) indicates a process of calculating the sum of z[i] from 0 to the reference signal count N−1 for i. y[i] is the pixel value of a decoded image in the index i. x[i] is the pixel value of a reference image in the index i. The count shift value iCountShift is the logarithm of 2 of the size of the reference region.

iCountShift=log 2 (Number of pixels of reference region) Formula (B-6)

The LM first parameter derivation section 310414 derives the first parameter a1 according to the following formula on the basis of the difference between the sum XY of the products of the objective reference pixels y and the input reference pixels x and the product of the sum Y of the objective reference pixels y and the sum X of the input reference pixels x.

a1=(XY<<iCountShift)−(Y*X); Formula (B-7)

As indicated by Formula (B-7), the difference is computed after XY has been shifted leftward by the count shift value iCountShift and the product of Y and X has been shifted rightward by the integrated shift value precShift.

The LM second parameter derivation section 310415 derives the second parameter a2 according to the following formula on the basis of the difference between the sum XX of the squares of the input reference pixels x and the square of the sum X of the input reference pixels x.

a2=(XX<<iCountShift)−(X*X); Formula (B-8)

The first parameter a1 and the second parameter a2 thus derived are outputted to the LM parameter a derivation section 310416.

Further, in order to reduce a bit range required for operations, the LM first parameter derivation section 310414 and the LM second parameter derivation section 310415 may derive Formulae (B-7′) and (B-8′) by shifting Formulae (B-7) and (B-8) rightward by iCountShift in the following manner.

aveX=X>>iCountShift

aveY=Y>>iCountShift

a1=XY−((aveY*aveX)<<iCountShift); Formula (B-7′)

a2=XX−((aveX*aveX)<<iCountShift); Formula (B-8′)

At this time, aveX and aveY are the averages of X and Y derived by shifting X and Y rightward by iCountShift, respectively.

Further, in order to improve arithmetic precision, the LM first parameter derivation section 310414 and the LM second parameter derivation section 310415 may derive a1 by adding the product of aveX and remY and the product of aveY and remX to the difference between XY and a number based on the product of aveY and aveX and derive a2 by adding double the product of aveX and remX to the difference between XX and a number based on the product of aveX and aveX in the following manner, in consideration of the remX and the remY that are remainders when the averages aveX and aveY are derived.

aveX=X>>iCountShift

remX=X−aveX

aveY=Y>>iCountShift

remX=Y−aveY

a1=XY−((aveY*aveX)<<iCountShift)+(aveX*remY)+(aveY*remX); Formula (B-7″)

a2=XX−((aveX*aveX)<<iCountShift)+2*(aveX*remX); Formula (B-8″)

It should be noted that the LM integrated value derivation section 310412 may perform an addition after making a right shift by a predetermined integrated shift value precShift as indicated below at the time of derivation of the sum XY of the products of the objective reference pixels y and the input reference pixels x and the sum XX of the squares of the input reference pixels x.

XX=Σ(x[i]*x[i])>>precShift Formula (B-4′)

XY=Σ(y[i]*y[i])>>precShift Formula (B-5′)

It should be noted that the integrated shift value precShift may be derived from the following or the like.

precShift=Max(0,bitDepth−12) Formula (B-1)

It should be noted that in a case where the integrated shift value precShift is used, the first parameter a1 and the second parameter a2 may be computed as the differences between XY and XX shifted leftward by the count shift value iCountShift and the product of X and Y and the product of X and X shifted rightward by the integrated shift value precShift as indicated below, respectively.

a1=(XY<<iCountShift)−(Y*X)>>precShift

a2=(XX<<iCountShift)−(X*X)>>precShift

Although the method of least squares of normal decimal precision allows the parameter a to be estimated by a1/a2, the present patent adds regularization costs according to circumstances in order to improve the robustness of the parameter. Further, in order to perform integer arithmetic, the present patent further introduces a shift value iShift and derives, as the parameter a, the value (a1<<iShift)/a2 shifted leftward by iShift.

(LM Parameter Derivation Section of the Present Embodiment)

The LM parameter estimation section 31041 of the present embodiment is configured to be an image predicting device including: a linear prediction parameter derivation section that, with an input being sets of pixel values xi and pixel values yi corresponding to an index i (i=0 to N−1), derives linear prediction parameters a and b for predicting yi from xi; and a linear prediction section that generates a predicted image on the basis of the linear prediction parameters, wherein the linear prediction parameter derivation section includes means for deriving the linear prediction parameter a from a first parameter a1 derived on the basis of the sum XY of the products of the pixel values xi and the pixel values yi and the product of the sum X of the pixel values xi and the sum Y of the pixel values yi and a second parameter a2 derived on the basis of the sum XX of the products of the pixel values xi and the pixel values xi and the product of the sum X of the pixel values xi and the sum X of the pixel values xi, and the linear prediction parameter derivation section includes at least one of means for comparing the first parameter a1 with a predetermined threshold THN and, in a case where the first parameter a1 is less than the threshold THN or not greater than the threshold THN, subtracting a first cost a1costN from the first parameter a1 and means for comparing the first parameter a1 with a predetermined threshold THP and, in a case where the first parameter a1 is less than the threshold THP or not greater than the threshold THP, adding a second cost a1costP to the first parameter a1.

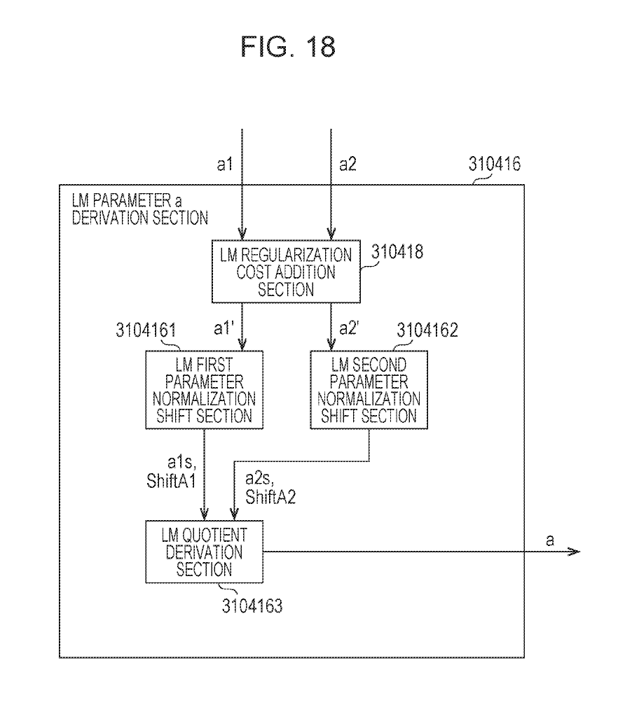

FIG. 18 is a block diagram showing a configuration of the LM parameter a derivation section 310416. The LM parameter a derivation section 310416 includes an LM regularization cost addition section 310418, an LM first parameter normalization shift section 3104161, an LM second parameter normalization shift section 3104162, and an LM quotient derivation section 3104163.

The LM parameter a derivation section 310416 restricts the first parameter a1 according to the magnitude of the second parameter a2 through an LM first parameter clip section (not illustrated). For example, a1 may be clipped to not less than −2*a2 and not greater than double a2 as indicated by the following formula.

a1=Clip3(−2*a2,(127*a2)>>6,a1) Formula (B-12)

According to the foregoing, the value of a1/a2 is clipped between −2 and 127/64. Accordingly, the value of a1/a2<<iShift, which is the value of the parameter a, is also clipped to −2<<iShift to (127/64)<<iShift. That is, in a case where iShift=6, the parameter a becomes −128 to 127 and falls within a range of 8-bit integers.

It should be noted that the clip is not limited to the foregoing but may be based on the following formula or the like.

a1=Clip3(−m1*a2,m2*a2,a1) Formula (B-12′)

Note here that m1 and m2 are positive integers. For example, values such as m1=2 to 3 and m2=2 to 3 are appropriate. For restrictions in finer units than integers, the clip may also be performed according to the following formula.

a1=Clip3(−(m1*a2>>m3),(m2*a2>>m43),a1) Formula (B-12″)

Note here that m1, m2, m3, and m4 are positive integers. For example, when m1=3, m2=3, m3=1, and m4=1, a1 can be restricted to a value −1.5 to 1.5 times larger than a2. That is, a1/a2 can be restricted between −1.5 to 1.5.

The LM parameter estimation section 31041 of the present embodiment includes, through the LM regularization cost addition section 310418, at least one means of an LM first parameter regularization cost addition section that compares the first parameter a1 with the predetermined threshold THN and, in a case where the first parameter a1 is not greater than the threshold THN, subtracts the first cost a1costN of not less than 0 from the first parameter a1 and an LM first parameter regularization cost addition section that compares the first parameter a1 with one or more predetermined thresholds THP and, in a case where the first parameter a1 is not less than the thresholds THP, adds the second cost a1costP of not less than 0 to the first parameter a1. Note here that the updated values obtained by subtracting or adding the regularization costs from or to the first parameter a1 and the second parameter a2 are also denoted by a1 and a2; however, in a case where a distinction is made between the values to be updated and the updated values, the parameters to be updated are denoted by a1 and a2 and the updated parameters are denoted by a1′, and a2′.

The LM regularization cost addition section 310418 subtracts the first cost a1costN of not less than 0 to the first parameter a1, for example, in a case where the first parameter a1 is smaller than the predetermined threshold THN or the first parameter a1 is not greater than the predetermined threshold THN. In addition, a specific configuration of the LM regularization cost addition section 310418 and a modification thereof will be described later.

a1=a1+a1costN

(LM Normalization Shift Section)

In the following, prior to the derivation of the parameter a corresponding to a1<<iShift/a2 by integer processing, the LM first parameter normalization shift section 3104161 derives a1s by adjusting the magnitude of a1 by shifting it, so that the range of values required for processing at the time of derivation does not become too large. Further, in order to restrict the size of a table to which to refer in a case of performing a division by a2, the LM second parameter normalization shift section 3104162 derives a2s by adjusting the magnitude of a2 by shifting it.

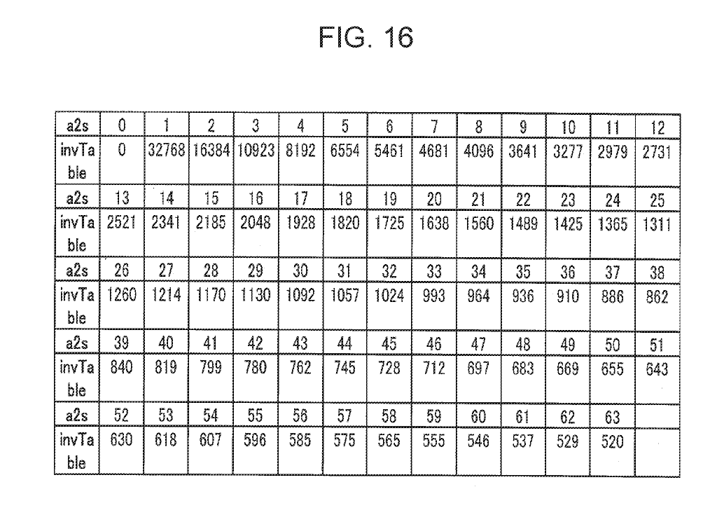

For a predetermined bit width ShiftA2 used in the derivation of the table of FIG. 16, the LM second parameter normalization shift section 3104162 derives a second normalization shift value iScaleShiftA2 according to the following formula depending on the magnitude of the second parameter a2. The second normalization shift value iScaleShiftA2 thus derived is outputted to the LM quotient derivation section 3104163.

iScaleShiftA2=Max(0,Floor(Log 2(Abs(a2)))−(ShiftA2−1)) Formula (B-14)

It should be noted that Floor(Log 2(Abs(x))) can be calculated using Number of Leading Zero (NLZ), which is a number of running zeros as seen from the left side Leftmost bit of a bit sequence when a2 is stored in a 32-bit register, according to

Floor(Log 2(Abs(x)))=32−NLZ(x).

It should be noted that in a case where a 64-bit register is used, Floor(Log 2(Abs(x))) can be derived by 64−NLZ(x).

It should be noted that since the derivation of NLZ requires comparatively complex calculations, it is preferable that the number be smaller.

The LM first parameter normalization shift section 3104161 derives a first normalization shift value iScaleShiftA1 according to the following formula depending on the second normalization shift value iScaleShiftA2. The first normalization shift value iScaleShiftA1 thus derived is outputted to the LM quotient derivation section 3104163.

iScaleShiftA1=Max(0,iScaleShiftA2−offsetA1) Formula (B-13)

It should be noted that offsetA1 is here a constant that satisfies not greater than 10.

In the foregoing, the derivation of the first normalization shift value on the basis of the second normalization shift value brings about an effect of facilitating a process of deriving a first normalization parameter.

It should be noted that the LM first parameter normalization shift section 3104161 may derive the first normalization shift value iScaleShiftA1 according to the following formula without depending on the second normalization shift value iScaleShiftA2.

iScaleShiftA1=Max(0,Floor(Log 2(Abs(a1)))−(ShiftA1−1))

Note here that ShiftA1 may be a fixed value such as 6 to 14 or may be a value such as a bit-depth-dependent value (e.g. bitDepth−2).

The LM first parameter normalization shift section 3104161 and the LM second parameter normalization shift section 3104162 derive a normalized first parameter a1s and a normalized second parameter a2s by shifting the first parameter a1 and the second parameter a2 rightward by the first normalization shift value iScaleShiftA1 and the second normalization shift value iScaleShiftA2, respectively.

a1s=a1>>iScaleShiftA1 Formula (B-15)

a2s=a2>>iScaleShiftA2 Formula (B-16)

It should be noted that in a case where the regularization costs are used, a1 and a2 of the foregoing formulae are replaced by a1′ and a2′ from or to which the regularization costs have been subtracted or added.

This allows the normalized first parameter a1s and the normalized second parameter a2s to be normalized to be values between 0 and the iShiftA1th power of 2-1 and between the ShiftA2th power of −2 and the ShiftA2th power of 2-1, respectively.

The LM quotient derivation section 3104163 derives a number equivalent to a1s/a2s. In the present embodiment, a number multiplied by (1<<ScaleShiftA) to be treated as an integer value is derived with use of a table.

The LM quotient derivation section 3104163 derives a parameter a shift value iScaleShiftA according to the following formula on the basis of the difference between the first normalization shift value iScaleShiftA1 and the second normalization shift value iScaleShiftA2.

ScaleShiftA=ShiftA1+iScaleShiftA2−iScaleShiftA1−iShift Formula (B-18)

Note here since iScaleShiftA1=Max(0, iScaleShiftA2−offsetA1), the following formula holds:

ScaleShiftA<=ShiftA1+iScaleShiftA2−(iScaleShiftA2−offsetA1)−iShift

ScaleShiftA<=ShiftA1+offsetA1−iShift

Since offsetA1 is not less than 0, iShift ranges from 5 to 8 bits, and ShiftA1 ranges from 14 bits to 15 bits, ScaleShiftA is always not less than 0.

The LM quotient derivation section 3104163 derives the parameter a according to the following formula by referring to an inverse table value invTable that is determined according to the normalized second parameter a2s, calculating the product of the inverse table value invTable and the normalized first parameter a1s, and shifting the product rightward by a table shift value (ScaleShiftA).

a=(a1s*invTable[a2s])>>(ScaleShiftA) Formula (B-19)

FIG. 16 is an inverse table value invTable[ ] that is used in the present embodiment. The inverse invTable[x] of FIG. 16 becomes 0 in a case where the index x is 0 and, in a case where the index x is not 0, is derived from an integer value obtained by dividing a predetermined constant (ShiftA2 of 2) by x. That is,

invTable[x]=0 (where x is 0) Formula (T-1)

invTable[x]=Floor((2̂ShiftA2/x/2)/x) (where x is not 0) Formula (T-2)

It should be noted that Floor(x) is a function for turning a number into an integer by dropping the fractional portion of the number. Formula (T-1) may be replaced by the following Formula (T-2′). That is, it is not necessary to perform a rounding adjustment that adds half the divisor x.

invTable[x]=Floor(M/x) (where x is not 0) Formula (T-2′)

The use of the inverse table value invTable[ ] allows an operation equivalent to a division by a2s to be achieved by the product of and an inverse table value invTable[a2s] equivalent to the inverse of a2s and a right shift equivalent to log 2(M).

The value of the parameter a is equivalent to a value obtained by shifting the ratio (a1/a2) of the first parameter a1 to the second parameter a2 leftward by iShift.

The parameter a thus derived is outputted to the LM parameter b derivation section 310417 and the LM prediction filter section 31042.

The LM parameter b derivation section 310417 derives the parameter b according to the following formula by dividing, by the number of pixels of the reference region, a value obtained by subtracting, from the sum Y of the objective reference pixels y, a value obtained by multiplying the sum X of the input reference pixels x by the parameter a and shifting the product by a fixed shift value iShift.

b=(Y−((a*X)>>iShift)+(1<<(iCountShift−1)))>>iCountShift Formula (B-20)

It should be noted that the right shift of iCountShift is equivalent to dividing the value by the number N of pixels of the reference region.

(LM Prediction Filter Section 31042)

In the case of TYPE 0, which predicts a chrominance component from a luminance component, or TYPE 1, which predicts a chrominance component from another chrominance component, the LM prediction filter section 31042 derives, with use of an estimated parameter derived by the LM parameter estimation section 31041, a predicted image after LM prediction predSamples′[ ] from a predicted image predSamples[ ] corresponding to a predicted block in an input reference pixel before LM prediction. For example, in a case where the parameter b is derived by Formula (B-20), the following formula is used.

predSamples′[x][y]=(a*predSamples[x][y]>>iShift)+b Formula (P-1)

It should be noted that in a case where there is a difference between samplings of the input reference pixels predSamples[x][y] and the predicted image predSamples′[ ], such as a case where a color component is 420, the pixels after sampling may be used as predSamples[x][y]. For example, in a case where the input reference pixels predSamples[x][y] are a luminance component and the predicted image predSamples′[ ] is a chrominance component, it is possible to use, as the input reference pixels predSamples[x][y], a block obtained by subsampling the predicted image of the input reference pixels into 2:1 or a block obtained by filtering the predicted image of the input reference pixels and then subsampling it into 2:1.

(LM Prediction Filter Section 31042′)

The LM prediction filter section 31042 is replaced by an LM prediction filter section 31042′, which is another configuration of the LM prediction filter section 31042. The LM prediction filter section 31042′ derives the predicted image after LM prediction predSamples′[ ] according to the following formula from the predicted image before LM prediction predSamples[ ].

predSamples′[x][y]=(a*predSamples[x][y]+b>>iShift)) Formula (P-1′)

It should be noted that in a case of making a shift after adding the parameter b as in the case of the LM prediction filter section 31042′, the LM parameter b derivation section 310417 may be replaced by an LM parameter b derivation section 310417′, which is another configuration of the LM parameter b derivation section 310417. In this case, the parameter b may be derived according to the following formula by dividing, by the number of reference pixels, a value obtained by subtracting, from a value obtained by shifting the sum Y of the objective reference pixels y by the fixed shift value iShift, a value obtained by multiplying the sum X of the objective reference pixels x by the parameter a.

b=((Y<<iShift)−((a*X))+(1<<(iCountShift−1)))>>iCountShift Formula (B-20′)

(LM Prediction Filter Section 31042B)

As another configuration of the LM prediction filter section 31042, the following LM prediction filter section 31042B, which utilizes a residual, may be used.

The LM prediction filter section 31042B derives, with use of an estimated parameter derived by the LM parameter estimation section 31041, a predicted image after LM prediction predSamples′[ ] (e.g. of the Cr component of a second chrominance component) corresponding to an objective reference signal derived by a planar prediction, a DC prediction, a directional prediction, or the like from a predicted image predSamples[x][y] of a target color component corresponding to the objective reference signal and a residual image resSamples[x][y] of a reference color component (e.g. the Cb component of a first chrominance component) corresponding to an input reference signal.

predSamples′[x][y]=predSamples[x][y]+(a*resSamples[x][y]>>iShift) Formula (P-2)

As described above, the LM prediction filter section 31042B operates to predict a residual image in a target color component from a residual image in a reference color component by utilizing a linear prediction and update a predicted image in the target color component by using the residual image thus predicted.

The configuration utilizing a residual image is effective especially in TYPE 1, which predicts a chrominance component from another chrominance component, but can also be utilized in TYPE 0, which predicts a chrominance component from a luminance component.

(LM Parameter Estimation Section 31041A)

The following describes an LM parameter estimation section 31041A as a configuration of the LM parameter estimation section 31041 according to the present embodiment. The LM parameter estimation section 31041A (LM regularization cost addition section 310418A) is characterized by subtracting the first cost a1costN of not less than 0 to the first parameter a1 in a case where the first parameter a1 is smaller than the predetermined threshold THN or a case where the first parameter a1 is not greater than the predetermined threshold THN.

It should be noted that since the subtraction of a regularization cost of not less than 0 is equivalent to the addition of a regularization cost of not greater than 0, all configurations of the subtraction of a regularization cost may be replaced by the addition of a regularization cost (same applies below).

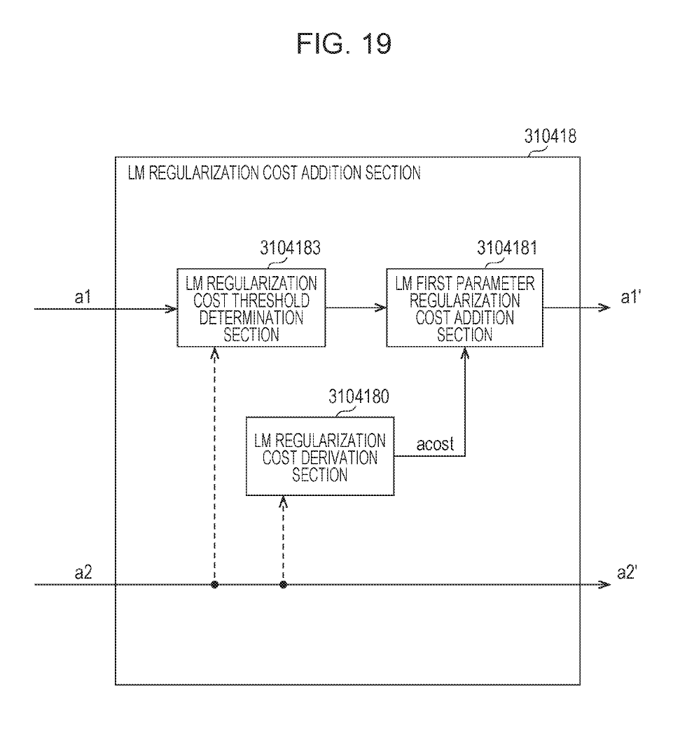

FIG. 19 is a block diagram showing a configuration of the LM regularization cost addition section 310418 (LM regularization cost addition section 310418A, LM regularization cost addition section 310418B, LM regularization cost addition section 310418C) of the LM parameter a derivation section 310416. The LM regularization cost addition section 310418 includes an LM regularization cost derivation section 3104180, an LM regularization cost threshold determination section 3104183, and an LM first parameter regularization cost addition section 3104181.

The LM regularization cost derivation section 3104180 derives a regularization cost acost. The regularization cost acost thus derived is used as a first parameter cost a1costN. The LM regularization cost derivation section 3104180 will be described in detail later.

The LM parameter estimation section 31041A (LM regularization cost addition section 310418A) according to the present embodiment makes a determination of the magnitude of the first parameter a1 and a threshold and adds a regularization cost to the first parameter a1 on the basis of the determination. More specifically, the LM regularization cost threshold determination section 3104183 compares the first parameter a1 with the threshold THN and, in a case where the first parameter a1 is less than the threshold THN (or the first parameter a1 is not greater than the threshold THN), subtracts the first parameter regularization cost a1costN to the first parameter a1 through the LM first parameter regularization cost addition section 3104181. On the other hand, in a case where the first parameter a1 is not less than the threshold THN, the LM regularization cost threshold determination section 3104183 does not subtract the first parameter regularization cost a1costN.

a1′=a1−a1costN

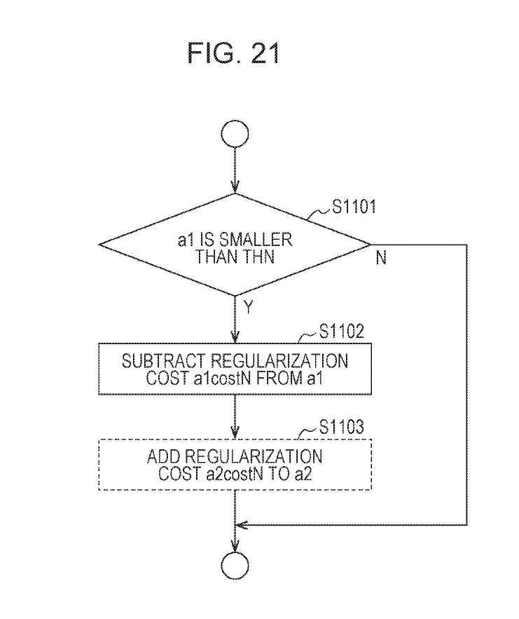

An operation of the LM regularization cost addition section 310418A is described again with reference to S1101 and S1102 of the flow chart of FIG. 21.

S1101 The LM regularization cost threshold determination section 3104183 compares the first parameter a1 with the threshold THN. In a case where the first parameter a1 is less than the threshold THN (or the first parameter a1 is not greater than the threshold THN), a transition is made to S1102.

S1102 The LM parameter a derivation section 310416 subtracts the first parameter regularization cost a1costN to the first parameter a1 through the LM first parameter regularization cost addition section 3104181. The parameter a1 after subtraction is also called “a1′”.

The operation of the LM regularization cost addition section 310418B ends here.

It should be noted that although the LM regularization cost addition section 310418B does not add a regularization cost a1costN to the second parameter a2, the LM regularization cost addition section 310418B may execute S1203 subsequent to S1202 to add the second parameter regularization cost a2costN to the second parameter a2 like the after-mentioned LM regularization cost addition section 310418B2.

S1103 An LM second parameter regularization cost addition section 3104182 adds the second parameter regularization cost a2costN to the second parameter a2. The second parameter a2 after addition is also called “a2′”.

It should be noted that the addition of a regularization cost is not performed by the LM regularization cost addition section 310418, which is a separate device, after the derivation of the first parameter a1 and the second parameter a2 by the LM first parameter derivation section 310414 and the LM second parameter derivation section 310415 but may be performed at the same time as the derivation of the first parameter a1 and the second parameter a2 by the LM first parameter derivation section 310414 and the LM second parameter derivation section 310415. The LM parameter estimation section 31041 of this configuration uses the following Formulae (BC-7), (BC-7′), and (BC-7″) instead of the aforementioned Formulae (B-7), (B-7′), and (B-7″) in the LM first parameter derivation section 310414 and the LM second parameter derivation section 310415.

a1=(XY<<iCountShift)−X*Y−a1costN; Formula (BC-7)

a1=XY−((aveY*aveX)<<iCountShift)−a1costN; Formula (BC-7′)

a1=XY−((aveY*aveX)<<iCountShift)+(aveX*remY)+(aveY*remX)−a1costN; Formula (BC-7″)

(Specific Example)

The following describes an example of a case where the regularization cost a1costN takes on a specific value. In this example, a1costN is derived on the basis of the second parameter a2 (LM regularization cost derivation section 3104180D, see Formula (C-1D)). For example, in a case where a1costN is not greater than a value obtained by dividing a k multiple of a2 by L,

a1costN=k*a2/L.

With use of the first parameter a1′ and the second parameter a2′ after the addition (subtraction) of the regularization costs, the parameter a, which is equivalent to a1/a2, is derived according to the following formula.

a1′/a2′=(a1+a1costN)/a2=a1/a2−k/L.

Note here that in a case where k=1 and L=32, k/L=0.0315, and the effect of the regularization cost is equivalent to subtracting an offset 0.0315 of a small value from the parameter a (a1/a2) in a case where a1 is less than the threshold THN.

It should be noted that an experiment conducted by the inventors has made it clear that it is preferable that the LM regularization cost threshold determination section 3104183A set the threshold THN at 0 as indicated by Formula (D-1) or a multiple of a2 as indicated by Formula (D-1′).

THN=0 Formula (D-1)

THN=−(a2>>tshift2) Formula (D-1′)

(Explanation)

The inventors found that the parameter a, which is derived by the method of least squares, is often smaller in absolute value than a value optimum for the generation of a predicted image (closer to 0 than the optimum value). The adjustment of the parameter a by a regularization cost can be done in either of the following two ways. On the one hand, in a case where the parameter a is made larger in absolute value by being brought close toward the positive, it is necessary to add a regularization cost of not less than 0 to the parameter a1. On the other hand, in a case where the parameter a is made larger in absolute value by being brought close toward the negative, it is necessary to subtract a regularization cost of not less than 0 from the parameter a1. In this way, it is necessary to change between the addition and subtraction of a regularization cost depending on the sign of the parameter a. To that end, it is necessary to determine the sign of the parameter a before adjusting the magnitude of the first parameter a1 with a regularization cost. For this determination, the LM parameter estimation section 31041 (including a modification) utilizes the sign of the first parameter a1 or the result of a comparison between the first parameter a1 and the predetermined threshold.

The parameter a is derived as a value equivalent to an integer multiple (1<<iShift multiple) of a1/a2. Since the second parameter a2 is always not less than 0, the sign of the parameter a (=the sign of a1/a2) is equal to the sign of the first parameter a1. Therefore, the sign and magnitude of the parameter a can be derived by the comparison between the first parameter a1 and the predetermined threshold.

It can be understood that, by subtracting the regularization cost a1costN from a1, for example, in a case where a1 is less than THN (here, THN=0), the LM parameter estimation section 31041 can bring the value of the parameter a close toward the farther side (here, toward the negative) from 0 than a value that is derived by the method of least squares. The foregoing configuration allows the LM parameter estimation section 31041 to derive linear prediction parameters having resistance to noise, thus bringing about an effect of improving the prediction accuracy with which a predicted image is generated.

It should be noted that a1costN, a1costP, a1costN, and a1costP mean a regularization cost to a1 that brings the parameter a close substantially toward the negative, a regularization cost to a1 that brings the parameter a close substantially toward the positive, a regularization cost to a2 that brings the parameter a close substantially toward the negative, and a regularization cost to a2 that brings the parameter a close substantially toward the positive, respectively. In a case where no distinctions are made among them, acost, a1cost, a2cost, acostN, acostP, and the like are simply used.

It should be noted that THN=0 is suitable as the predetermined threshold in terms of bringing the value of the parameter a close toward the farther side from 0. That is, the LM regularization cost threshold determination section 3104183 is suitably configured to compare the first parameter a1 with the threshold THN and, in a case where the first parameter a1 is less than the threshold THN of not less than 0 (or the first parameter a1 is not greater than the threshold THN), add the first parameter regularization cost a1costN to the first parameter a1 through the first parameter LM regularization cost addition section 3104181.

However, depending on the image, another value close to THN=0 is also suitable. Examples include THN=−a2>>tshift (where tshift is a constant of 2 to 8) and the like. For example, in a case where tshift=4, it is possible to bring the value of the parameter a close to the farther side (here, toward the negative) from 0 in a case where a1 is less than −a2/16, that is, a1/a2 is less than −1/16. It is also possible to prevent a constraint term to forcibly have effect in a case where the value of the parameter a is close to 0. On the other hand, it is also possible to set THN=a2>>tshift (where tshift is a constant of 2 to 8). For example, in a case where tshift=4, it is possible to bring the value of the parameter a close to the farther side (here, toward the negative) from 0 in a case where a1 is less than a2/16, that is, a1/a2 is less than 1/16. Here, even in a case where the parameter a is positive and very close to 0, the regularization costs can bring the value of the parameter a close toward the negative.

It should be noted that although, in the present embodiment, the LM parameter estimation section 31041 brings the parameter a to the farther side from 0 by bringing the value of the parameter a even closer toward the negative with use of a regularization cost in a case where the parameter a is negative, it is also possible to bring the parameter a close toward the farther side from 0 by bringing the value of the parameter a close toward the positive with use of a regularization cost in consideration of a case where the parameter a is positive. This example is described as an LM parameter estimation section 31041B. Furthermore, a configuration taking both positive and negative cases into account is described as an LM parameter estimation section 31041C.

(LM Parameter Estimation Section 31041B)

The following describes the LM parameter estimation section 31041B as a configuration of the LM parameter estimation section 31041. The LM parameter estimation section 31041B (LM regularization cost addition section 310418B) is characterized by adding the first parameter regularization cost a1costP of not less than 0 to the first parameter a1 in a case where the first parameter a1 is larger than the predetermined threshold THP or a case where the first parameter a1 is not less than the predetermined threshold THP.

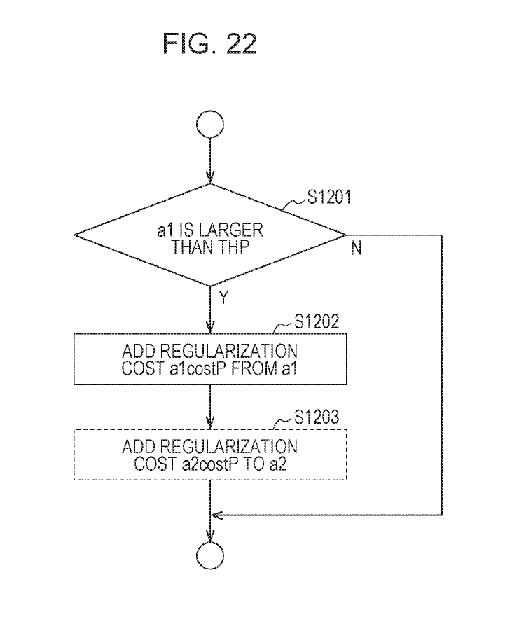

An operation of the LM regularization cost addition section 310418B is described again with reference to S1201 and S1202 of the flow chart of FIG. 22.

S1201 The LM regularization cost threshold determination section 3104183 compares the first parameter a1 with the threshold THN. In a case where the first parameter a1 is larger than the threshold THP (or the first parameter a1 is not less than the threshold THP), a transition is made to S1202.

S1202 The first parameter LM regularization cost addition section 3104181 adds the first parameter regularization cost a1costP to the first parameter a1 through the first parameter LM regularization cost addition section 3104181. The parameter a1 after addition is also called “a1′”.

The operation of the LM regularization cost addition section 310418B ends here.

It should be noted that although the LM regularization cost addition section 310418B does not add a regularization cost a2costP to the second parameter a2, the LM regularization cost addition section 310418B may execute S1203 subsequent to S1202 to add the second parameter regularization cost a2costP to the second parameter a2 like the after-mentioned LM regularization cost addition section 310418B2.

S1203 The LM second parameter regularization cost addition section 3104182 adds the second parameter regularization cost a1costP to the second parameter a2. The parameter a2 after addition is also called “a2′”.

The LM regularization cost derivation section 3104180 derives a regularization cost acost. acost derived by any one of the aforementioned Formulae (C-1A) to (C-1D2) or a combination thereof is derived as a first cost a1costP of a first parameter cost.

The LM regularization cost addition section 310418B according to the present embodiment makes a determination of the magnitude of the first parameter a1 and a threshold and adds a regularization cost to the first parameter a1 on the basis of the determination. More specifically, an LM regularization cost threshold determination section 3104183B compares the first parameter a1 with the threshold THP of not less than 0 and, in a case where the first parameter a1 is larger than the threshold THP (or the first parameter a1 is not less than the threshold THP), adds the first parameter regularization cost a1costP to the first parameter a1 through the LM first parameter regularization cost addition section 3104181. On the other hand, in a case where the first parameter a1 is not greater than the threshold THP (or less than the threshold THP), the LM regularization cost threshold determination section 3104183B does not add the first parameter regularization cost a1costP.

a1=a1+a1costP

It should be noted that the addition of a regularization cost may be performed by the LM first parameter derivation section 310414 and the LM second parameter derivation section 310415. The deriving formulae are the ones obtained by substituting a1costN with a1costP in the already-described Formulae (BC-7), (BC-7′), and (BC-7″).

(Specific Example)

The following describes an example of a case where the regularization cost a1costN takes on a specific value. In this example, a1costN is derived on the basis of the second parameter a2 (LM regularization cost derivation section 3104180D, see Formula (C-1D)).

a1costP=k*a2/L

(a1+a1costP)/a2=a1/a2−k/L.

Since k/L=0.0315 in a case where k=1 and L=32, the regularization cost is equivalent to adding an offset 0.0315 of a small value to the parameter a (a1/a2) in a case where a1 is larger than the threshold THP. This makes it possible to, by adding the regularization cost a1costP to a1, for example, in a case where a1 is larger than THP (here, THP=0), bring the value of the parameter a close toward the farther side (here, toward the positive) from 0 than a value that is derived by the method of least squares, thus bringing about an effect of improving the prediction accuracy with which a predicted image is generated.

It should be noted that an experiment conducted by the inventors has made it clear that it is preferable that the LM regularization cost threshold determination section 3104183B set the threshold THP at 0 as indicated by Formula (D-2) or a multiple of a2 as indicated by Formula (D-2′).

THP=0 Formula (D-2)

THP=a2>>tshift2 Formula (D-2′)

(LM Parameter Estimation Section 31041C)

The following describes the LM parameter estimation section 31041C as a configuration of the LM parameter estimation section 31041. The LM parameter estimation section 31041C is a configuration obtained by combining the LM parameter estimation section 31041A and LM parameter estimation section 31041B in the addition of regularization costs (LM regularization cost addition section 310418). The LM parameter estimation section 31041C is characterized by subtracting the first cost a1costN of not less than 0 to the first parameter a1 in a case where the first parameter a1 is smaller than the predetermined threshold THN or a case where the first parameter a1 is not greater than the predetermined threshold THN and, furthermore, adding the second cost a1costP of not less than 0 to the first parameter a1 in a case where the first parameter a1 is larger than the predetermined threshold THP or a case where the first parameter a1 is not less than the predetermined threshold THP.

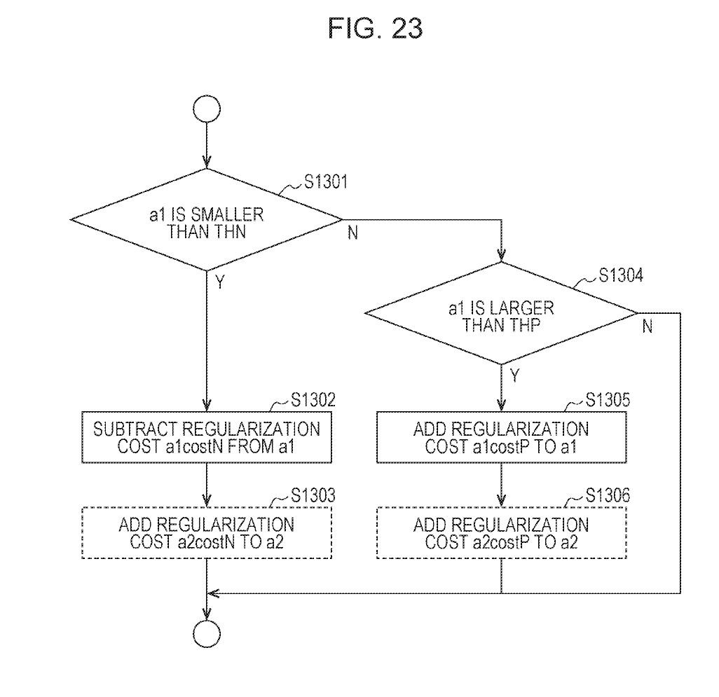

An operation of the LM parameter estimation section 31041C (LM regularization cost addition section 310418C) is described again with reference to the flow chart of FIG. 23.

S1301 The LM regularization cost threshold determination section 3104183 compares the first parameter a1 with the threshold THN. In a case where the first parameter a1 is less than the threshold THN (or the first parameter a1 is not greater than the threshold THN), a transition is made to S1302.

S1302 The first parameter LM regularization cost addition section 3104181 adds the first parameter regularization cost a1costN to the first parameter a1 through the first parameter LM regularization cost addition section 3104181. The parameter a1 after addition is also called “a1′”.

The LM regularization cost addition section 310418C skips S1303 and makes a transition to S1304. It should be noted that although the LM regularization cost addition section 310418C does not perform the operation of S1303, it may alternatively be configured to execute S1303 subsequent to S1302 to add the a2 parameter regularization cost a1costN to the second parameter a2 like the after-mentioned LM regularization cost addition section 310418C2.

S1303 The LM second parameter regularization cost addition section 3104182 adds the second parameter regularization cost a2costN to the second parameter a2 through the LM second parameter regularization cost addition section 3104182. The parameter a2 after addition is also called “a2′”.

S1304 The LM regularization cost threshold determination section 3104183 compares the first parameter a1 with the threshold THP. In a case where the first parameter a1 is larger than the threshold THP (or the first parameter a1 is not less than the threshold THP), a transition is made to S1305.

S1305 The first parameter LM regularization cost addition section 3104181 adds the first parameter regularization cost a1costP to the first parameter a1 through the LM first parameter regularization cost addition section 3104181. The parameter a1 after addition is also called “a1′”.

The operation of the LM regularization cost addition section 310418C ends here. It should be noted that although the LM regularization cost addition section 310418C does not perform the operation of S1306, it may alternatively be configured to execute S1306 subsequent to S1305 to add the second parameter regularization cost a2costP to the second parameter a2 like the after-mentioned LM regularization cost addition section 310418C2.

S1306 The LM second parameter regularization cost addition section 3104182 adds the second parameter regularization cost a2costP to the second parameter a2 through the second parameter LM regularization cost addition section 3104182. The parameter a2 after addition is also called “a2′”.

The LM regularization cost derivation section 3104180 derives a regularization cost acost. For example, the regularization cost acost is derived by any one of the already-described Formulae (C-1A) to (C-1D2) or a combination thereof.

The LM regularization cost addition section 310418C according to the present embodiment makes a determination of the magnitude of the first parameter a1 and a threshold and adds regularization costs to the first parameter a1 and the second parameter a2 on the basis of the determination. More specifically, an LM regularization cost threshold determination section 3104183C compares the first parameter a1 with the threshold THN of not less than 0 and, in a case where the first parameter a1 is smaller than the threshold THN (or the first parameter a1 is not greater than the threshold THN), subtracts the first parameter regularization cost a1costN from the first parameter a1 through the first parameter LM regularization cost addition section 3104181. In other cases, the LM regularization cost threshold determination section 3104183C compares the first parameter a1 with the threshold THP of not less than 0 and, in a case where the first parameter a1 is larger than the threshold THP (or the first parameter a1 is not less than the threshold THP), adds the first parameter regularization cost a1costP to the first parameter a1 through the first parameter LM regularization cost addition section 3104181. On the other hand, in a case where the first parameter a1 is not less than the threshold THN, the LM regularization cost threshold determination section 3104183C does not add the first parameter regularization cost a1costP.

Note here that, as the regularization cost a1costN for use in subtraction and the regularization cost a1costP for use in addition, the same values may be used (a1costN=a1costP=acost) or different values may be used. For example, the regularization cost a1costP for use in addition may be derived in the following manner as being not greater than the first parameter regularization cost a1costN for use in subtraction.

a1costN=(kM*a2)>>kshiftM

a1costP=(kP*a2)>>kshiftP

Note here that kM>kP or kshiftP>kshiftM. For example, it is only necessary that kM=kP=1, kshiftM=5, and kshiftP=6.

Although the LM parameter estimation sections 31041A, 31041B, and 31041C hitherto described are based on the inventors' findings that it is preferable that the parameter a be brought close to a far side away from 0, a further detailed discussion has shown that in a case where the absolute value of the parameter a is sufficiently large, bringing the parameter a to a farther side away from 0 may make the absolute value of the parameter a too larger than the intended optimum value. This is because, in some cases, the effect of noise may make the parameter a larger, although the effect of noise basically makes it comparatively highly probable that the parameter a becomes smaller, and in particular, in a case where the parameter a, which is derived without a regularization cost calculated by the method of least squares, is sufficiently large, the probability becomes higher. LM parameter estimation sections 31041A2, 31041B2, and 31041C2, which are described below, solve these problems, albeit with slightly more complex configurations.

While the LM parameter estimation sections 31041A, 31041B, and 31041C add or subtract regularization costs to or from the first parameter a1 as LM regularization costs, the LM parameter estimation sections 31041A2, 31041B2, and 31041C2 are configured to add a regularization cost to the second parameter a2 while adding or subtracting a regularization cost to or from the first parameter a1.

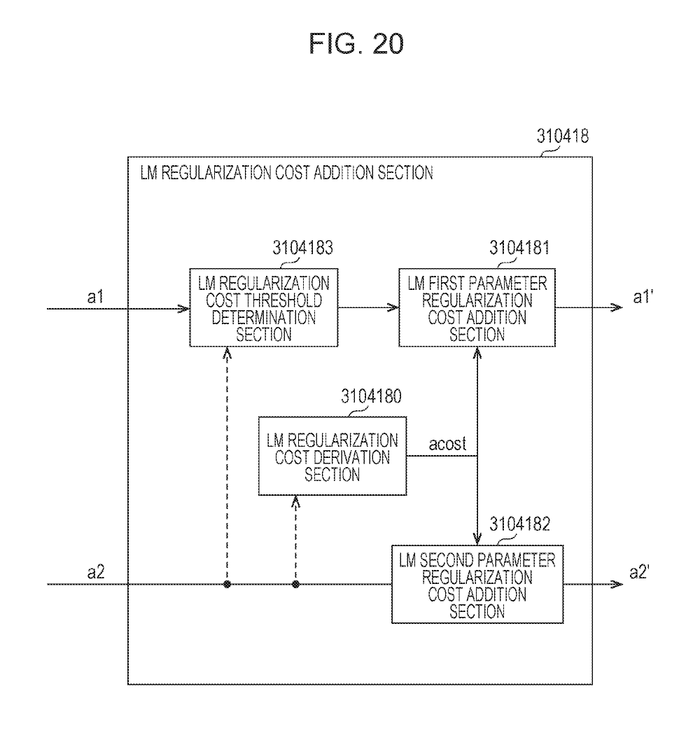

FIG. 20 is a block diagram showing a configuration of the LM regularization cost addition section 310418 (LM regularization cost addition section 310418A2, LM regularization cost addition section 310418B2, LM regularization cost addition section 310418C2) of the LM parameter estimation section 31041. The LM regularization cost addition section 310418 includes the LM regularization cost derivation section 3104180, the LM regularization cost threshold determination section 3104183, the LM first parameter regularization cost addition section 3104181, and the LM second parameter regularization cost addition section 3104182.

The LM parameter estimation section 31041 of FIG. 20 is characterized by including at least one of means for comparing the first parameter a1 with the predetermined threshold THN and, in a case where the first parameter a1 is less than the threshold THN or not greater than the threshold THN, subtracting the first cost a1costN from the first parameter a1 and adding the cost a2costN to the second parameter a2 and means for comparing the first parameter a1 with the predetermined threshold THP and, in a case where the first parameter a1 is less than the threshold THP or not greater than the threshold THP, adding the second cost a1costP to the first parameter a1 and adding the cost a1costP to the second parameter a2.

(LM Parameter Estimation Section 31041A2)

The following describes the LM parameter estimation section 31041A2 as a configuration of the LM parameter estimation section 31041. While the already-described LM parameter estimation section 31041A subtracts the first parameter regularization cost a1costN to the first parameter a1, the LM parameter estimation section 31041A2 adds the second parameter regularization cost a2costN to the second parameter a2 in addition to subtracting the regularization cost a1costN to the first parameter a1.

The LM parameter estimation section 31041A2 (LM regularization cost addition section 310418A2) operates according to the flow chart of FIG. 21. Details of each step of FIG. 21 are omitted as they have already been described in the LM regularization cost addition section 310418A.

In a case where the first parameter a1 is smaller than the predetermined threshold THN or a case where the first parameter a1 is not greater than the predetermined threshold THN (S1101), the LM regularization cost addition section 310418A2 subtracts the first cost a1costN of not less than 0 to the first parameter a1 (S1102) and adds the second cost a2costN of not less than 0 to the second parameter a2 (S1103).

In a case where a1cost N is subtracted to the first parameter a1 and a2costN is added to the second parameter a2, the parameter a is corrected to be close to −a1costN/a2costN.

The LM regularization cost derivation section 3104180 derives a regularization cost acost. For example, the regularization cost acost is derived by any one of the already-described Formulae (C-1A) to (C-1D2) or a combination thereof. Furthermore, a1costN and a2costN are derived from the regularization cost acost according to the following formulae.

a1costN=(acost>>kshift)

a2costN=acost

In the foregoing case, the parameter a is corrected to be close to −a1costN/a2costN=−(1>>kshift). Specifically, kshift=0, 1, 2, or 3 is appropriate, as it brings the parameter a close to 1, 0.5, 0.25, or 0.125.

It should be noted that although the regularization terms, which can be calculated by making a shift, are easy to calculate, the foregoing does not impose limits on the regularization costs. For example, the following formulae correct the parameter a so that the parameter a is close to k>>kshift.

a1costN=(k*acost)>>kshift

a2costN=acost

For example, if k=17 and kshift=5, it is possible to introduce such regularization terms so to bring the parameter a close to −17/32=−0.53125.

As described above, it is preferable that a2costN be not less than the cost a1costN, that is, it is preferable that a1costN/a2costN be not greater than 1.

The LM parameter estimation section 31041A2 (LM regularization cost addition section 310418A2) according to the present embodiment makes a determination of the magnitude of the first parameter a1 and a threshold and adds regularization costs to the first parameter a1 and the second parameter a2 on the basis of the determination. More specifically, the LM regularization cost threshold determination section 3104183A2 compares the first parameter a1 with the threshold THN of not less than 0 and, in a case where the first parameter a1 is less than the threshold THN (or the first parameter a1 is not greater than the threshold THN), adds the first parameter regularization cost a1costN to the first parameter a1 through the first parameter LM regularization cost addition section 3104181 and adds the second parameter regularization cost a2cost to the second parameter a2. On the other hand, in a case where the first parameter a1 is not less than the threshold THN, the LM regularization cost threshold determination section 3104183A2 does not add the regularization costs to the first parameter a1 and the second parameter a2.

The LM parameter estimation section 31041A2 (LM regularization cost addition section 310418A2) thus configured makes it possible to, by subtracting the first parameter regularization cost a1costN to the first parameter a1 and adding the second parameter regularization cost a2costN to the second parameter a2, bring the value of the parameter a close toward the nearer side to −a1costN/a2costN than a value that is derived by the method of least squares, thus bringing about an effect of improving the prediction accuracy with which a predicted image is generated. Whereas the LM regularization cost addition section 310418A simply brings the value of the parameter a close to the farther side from 0 than a value that is derived by the method of least squares, the LM parameter estimation section 31041A2 (LM regularization cost addition section 310418A2) brings the value of the parameter a close to −a1costN/a2costN by also adding the second parameter regularization cost a2costN to the second parameter a2. A tilt a suited to a luminance-chrominance prediction lies between 0 and −1 in a case where a is negative; therefore, in a case where a value that is derived by the method of least squares is sufficiently small as a negative value (smaller than −a1costN/a2costN) as in the case of the LM regularization cost addition section 310418B, the harmful effects of making the value even smaller can be eliminated. This brings about an effect of making it possible to derive even more highly accurate linear prediction parameters than the LM parameter estimation section 31041A (LM regularization cost addition section 310418A).

(Specific Example)

The following describes an example of a case where the regularization cost a1costN takes on a specific value. In this example, a1costN is derived on the basis of the second parameter a2 (LM regularization cost derivation section 3104180D, see Formula (C-1D)).

An experiment conducted by the inventors has shown, for example, that the following combinations of Examples 1 to 4 are preferred regularization costs.
Example 1: acost=(a2>>4), kshift=1 a1costN=(k*acost)>>kshift=a2>>5 a2costN=acost=a2>>4
Example 2: acost=(a2>>3), kshift=1 a1costN=(k*acost)>>kshift=a2>>4 a2costN=acost=a2>>3
Example 3: acost=(a2>>3), kshift=2 a1costN=(k*acost)>>kshift=a2>>5 a2costN=acost=a2>>3
Example 4: acost=(a2>>2), kshift=2 a1costN=(k*acost)>>kshift=a2>>4 a2costN=acost=a2>>2

It should be noted that although the foregoing combinations of regularization costs have been confirmed to achieve a favorable effect, an embodiment of the present invention is not limited to the foregoing values.

(LM Parameter Estimation Section 31041B2)

The following describes the LM parameter estimation section 31041B2 as a configuration of the LM parameter estimation section 31041. While the already-described LM parameter estimation section 31041B adds the first parameter regularization cost a1costN to the first parameter a1, the LM parameter estimation section 31041B2 adds the second parameter regularization cost a2costN to the second parameter a2 in addition to adding the first parameter regularization cost a1costN to the first parameter a1.

The LM regularization cost addition section 310418B2 operates according to the flow chart of FIG. 21. Details of each step of FIG. 21 are omitted as they have already been described in the LM regularization cost addition section 310418B.

In a case where the first parameter a1 is larger than the predetermined threshold THP or a case where the first parameter a1 is not less than the predetermined threshold THP (S1201), the LM regularization cost addition section 310418B2 subtracts the first cost a1costP of not less than 0 to the first parameter a1 (S1202) and adds the second cost a2costP of not less than 0 to the second parameter a2 (S1203).

The LM parameter estimation section 31041B2 (LM regularization cost addition section 310418B2) thus configured makes it possible to, by adding the first parameter regularization cost a1costP to the first parameter a1 and adding the second parameter regularization cost a2costP to the second parameter a2, bring the value of the parameter a close toward the nearer side to a1costP/a2costP than a value that is derived by the method of least squares, thus bringing about an effect of improving the prediction accuracy with which a predicted image is generated. Whereas the LM parameter estimation section 31041B (LM regularization cost addition section 310418B) simply brings the value of the parameter a close to the farther side from 0 than a value that is derived by the method of least squares, the LM parameter estimation section 31041B2 (LM regularization cost addition section 310418B2) brings the value of the parameter a close to a1costP/a2costP by also adding the second parameter regularization cost a2costP to the second parameter a2. In an inter color component prediction, for example, a tilt A [a] suited to a case of predicting a chrominance component from a luminance component often takes on a value of not less than 0 and less than 1 in a case where a is positive; therefore, in a case where a value that is derived by the method of least squares is sufficiently large (larger than a1costP/a2costP) as in the case of the LM regularization cost addition section 310418B, the harmful effects of making the value even larger can be eliminated. This brings about an effect of making it possible to derive even more highly accurate linear prediction parameters than the LM parameter estimation section 31041B.

(Specific Example)

The following describes an example of a case where the regularization cost a1costP takes on a specific value. In this example, a1costN is derived on the basis of the second parameter a2 (LM regularization cost derivation section 3104180D, see Formula (C-1D)).

a1costN=a2>>5

a2costN=a2>>4

As described above, it is preferable that a2costP be not less than the cost a1costP, that is, it is preferable that a1costP/a2costP be not greater than 1.

(LM Regularization Cost Addition Section 310418C2)

The following describes the LM regularization cost addition section 310418C2 as a configuration of the LM regularization cost addition section 310418. While the already-described LM regularization cost addition section 310418C subtracts or adds the first parameter regularization costs (a1costN and a1costP) from or to the first parameter a1, the LM regularization cost addition section 310418C2 adds the second parameter regularization costs (a1costN and a2costP) to the second parameter a2 in addition to adding the first parameter regularization costs (a1costN and a1costP) to the first parameter a1.

The LM regularization cost addition section 310418C2 operates according to the flow chart of FIG. 21. Details of each step of FIG. 21 are omitted as they have already been described in the LM regularization cost addition section 310418C.

The LM regularization cost addition section 310418C2 according to the present embodiment is characterized by, in a case where the first parameter a1 is smaller than the predetermined threshold THN or a case where the first parameter a1 is not greater than the predetermined threshold THN (S1301), subtracting the first cost a1costN of not less than 0 to the first parameter a1 (S1302) and adding the second cost a2costN of not less than 0 to the second parameter a2 (S1303) and, furthermore, by, in a case where the first parameter a1 is larger than the predetermined threshold THP or a case where the first parameter a1 is not less than the predetermined threshold THP (S1304), adding the third cost a1costP of not less than 0 to the first parameter a1 (S1305) and adding the fourth cost a2costP of not less than 0 to the second parameter a2 (S1306).

The LM parameter estimation section 31041C2 (LM regularization cost addition section 310418C2) thus configured makes it possible to, by not only subtracting the first parameter regularization cost a1costN or adding a1costP from or to the first parameter a1 but also adding the second parameter regularization cost a2costN or a2costP to the second parameter a2, bring the value of the parameter a close toward the nearer side to a1costN/a2costN (or a1costP/a2costP) as an absolute value than a value that is derived by the method of least squares, thus bringing about an effect of improving the prediction accuracy with which a predicted image is generated. A tilt a suited to a luminance-chrominance prediction often takes on a value of not less than 0 and less than 1 in a case where a is positive; therefore, in a case where a value that is derived by the method of least squares is sufficiently large as an absolute value (larger than −a1costP/a2costP) as in the case of the LM regularization cost addition section 310418C, the harmful effects of making the value even larger can be eliminated. This brings about an effect of making it possible to derive even more highly accurate linear prediction parameters than the LM parameter estimation section 31041C (LM regularization cost addition section 310418C).

(LM Regularization Cost Derivation Section 3104180)

The following describes the details of the LM regularization cost derivation section 3104180 of the LM parameter estimation section 31041. The LM regularization cost derivation section 3104180 may perform derivation, for example, according to any one of the following Formulae (C-1A) to (C-1D2) or a combination thereof.

acost=XX>>ashift Formula (C-1A)

acost=XY>>ashift Formula (C-1B)

acost=1<<(2*bitDepth)*N>>ashift Formula (C-1C)

acost=1<<(2*bitDepth)<<CountShift>>ashift Formula (C-1C2)

acost=k*a2>>kshift) Formula (C-1D)

acost=min(k*a2>>kshift,acost0) Formula(C-1D2)

It should be noted that, for example, an experiment conducted by the inventors has confirmed that it is preferable that “ashift” of Formulae (C-1A) to (C-1D) range from 6 to 12. “N” of Formula (C-1C) may be the number of input reference signals (1<<iCountShift) or, in a case where the number of input reference signals is large ranging from 8 to 16, it may be a number ranging from 8 to 16. “k” and “kshift” of Formula (C-1D2) will be described later.

(LM Regularization Cost Derivation Section 3104180A)

The following describes an LM regularization cost derivation section 3104180A as a configuration of the LM regularization cost derivation section 3104180. The LM regularization cost derivation section 3104180A derives a regularization cost on the basis of the sum XX of the products of the input reference signals x and the input reference signals x. This value is always not less than 0.

acost=XX>>ashift Formula (C-1A)

The second parameter a2 is calculated by subtracting a predetermined value from the sum XX of the products of the input reference signals x and the input reference signals x as indicated by the already-described Formula a2=XX−((aveX*aveX)<<iCountShift). Therefore, the regularization cost that is derived by the sum XX of the products of the input reference signals x and the input reference signals x is expected to fall within the same level of range of values as the second parameter a2 and is appropriate as a regularization cost. The LM regularization cost derivation section 3104180A of the present configuration brings about an effect of making it possible to derive an appropriate regularization cost in a case where the ranges of values of the input reference pixels x and the objective reference pixels y[ ] are comparatively equal.

(LM Regularization Cost Derivation Section 3104180B)

The following describes an LM regularization cost derivation section 3104180B as a configuration of the LM regularization cost derivation section 3104180. The LM regularization cost derivation section 3104180B derives a regularization cost on the basis of the sum XY of the products of the input reference signals x and the objective reference signals y. This value is always not less than 0.

acost=XY>>ashift Formula (C-1B)

The first parameter a1 is calculated by subtracting a predetermined value from the sum XY of the products of the input reference signals x and the objective reference signals y as indicated by the already-described Formula XY−((aveY*aveX)<<iCountShift). Therefore, the regularization cost that is derived by XY is expected to fall within the same level of range of values as the first parameter a1 and is appropriate as a regularization cost. XY, which is derived from the sum of the products of the input reference pixels x[ ] and the objective reference pixels y[ ], brings about an effect of making it possible to derive an appropriate regularization cost regardless of the range of values of the input reference pixels x and the range of values of the objective reference pixels y[ ].

(LM Regularization Cost Derivation Section 3104180C)

The following describes an LM regularization cost derivation section 3104180C as a configuration of the LM regularization cost derivation section 3104180. The LM regularization cost derivation section 3104180C derives a regularization cost on the basis of bitDepth. This value is always not less than 0.

acost=1<<(2bitDepth)*N>>ashift Formula (C-1C)

For example, in a case where the bit depth of the input reference pixels x[ ] and the objective reference pixels y[ ] is bitDepth, x and y are often numbers around 1>>(bitDepTHN). Specifically, in a case where bitDepth=8, i.e., in a case where the luminance and the chrominance take on values ranging from 0 to 255, the values of luminance and chrominance are comparatively often around 128. Therefore, it is expected that, even without the use of actual input reference pixels x[ ] and objective reference pixels y[ ], an appropriate regularization cost is derived by substituting the input reference pixels x and the objective reference pixels y with a bit-depth-dependent value (x[i]=y[i]=1>>(bitDepTHN)) and using the already-described Formulae (C-1A) and (C-1B). On the basis of this idea, the LM regularization cost derivation section 3104180C derives a regularization cost according to the following formula.

acost=1>>(2*bitDepth)>>CountShift>>ashift Formula (C-1C2)

The bitDepth-based method of the LM regularization cost derivation section 3104180C does not involve the use of the input reference pixels x or the objective reference pixels y[ ] and therefore brings about an effect of making it possible to derive a regularization cost with a comparatively small number of operations.

(LM Regularization Cost Derivation Section 3104180D)

The following describes an LM regularization cost derivation section 3104180D as a configuration of the LM regularization cost derivation section 3104180. The LM regularization cost derivation section 3104180D derives a regularization cost on the basis of the second parameter a2, for example, according to the following formula. This value is always not less than 0.

acost=k*a2>>kshift Formula (C-1D)

For example, k=1 and kshift=2.

The second parameter a2 is equivalent to a variance of the input reference pixels x[ ]. The regularization cost is added or subtracted to or from the first parameter a1 and the second parameter a2; however, in a case where the second parameter a2 is comparatively small, a case of adding the regularization cost acost, which is too larger than the second parameter a2, to a2 undesirably results in too great a change in value. By deriving a regularization cost on the basis of the second parameter a2, the present embodiment brings about an effect of preventing the regularization cost from being too highly effective.

(LM Regularization Cost Derivation Section 3104180D2)

Furthermore, the LM regularization cost derivation section 3104180D, which derives a regularization cost on the basis of the second parameter a2, may derive the regularization cost acost by clipping, to a value that is derived from a2, an upper limit of the regularization cost acost derived by XX, XY, bitDepth, or the like (LM regularization cost derivation section 3104180D2). This value is always not less than 0.

The regularization cost is added or subtracted to or from the first parameter a1 and the second parameter a2; however, in a case where the second parameter a2 is comparatively small, a case of adding the regularization cost acost, which is too larger than the second parameter a2, to a2 undesirably results in too great a change in value. Therefore, it is appropriate to derive the regularization cost acost per se in accordance with the magnitude of the second parameter a2. This brings about an effect of preventing an appropriate regularization cost from being too highly effective.

acost=min(k*a2>>kshift,acost0) Formula(C-1D2)

Note here that acost0 is a regularization cost acost that is derived by any of the LM regularization cost derivation sections 3104180A, 3104180B, and 3104180C hitherto described. By deriving acost0, which serves as a base, and the maximum value of a value (here, k*a2>>kshift) that is derived from a2, which defines an upper limit, the LM regularization cost derivation section 3104180A can perform a clip according to the magnitude of a2 for the regularization cost to be derived. In general, a regularization cost is a parameter that, in a case where the reliability of a1 and a2 is low due to noise or the like, is added or subtracted in order to stabilize an estimated parameter. However, in a case where the value of a2, which is equivalent to a variance (ΣXX−ΣXX/N) of x, is comparatively small, a case of adding the regularization cost acost, which is too larger than the second parameter a2, to a2 undesirably results in the regularization cost being too highly effective against the linear prediction parameters to be estimated. Therefore, it is appropriate to fit the regularization cost acost to the magnitude of the second parameter a2, which is a term to which the regularization cost acost is added. This brings about an effect of preventing the regularization cost from being too highly effective.

An experiment conducted by the inventors shows that while Formula (C-1D2) has favorable prediction accuracy, Formula (C-1D), too, can achieve close accuracy. Since Formula (C-1D) makes it easier to derive a regularization term, it is also effective to use Formula (C-1D).

The inverse quantization and inverse DCT section 311 calculates a DCT coefficient by inversely quantizing the quantized coefficient inputted from the entropy decoding section 301. The inverse quantization and inverse DCT section 311 computes a decoded residual signal by performing inverse DCT (inverse discrete cosine transform) on the DCT coefficient thus calculated. The inverse quantization and inverse DCT section 311 outputs the decoded residual signal thus computed to the addition section 312 and the residual storage section 313.

The addition section 312 generates a reference picture block by adding, for each pixel, the predicted picture blocks P inputted from the inter prediction image generation section 309 and the intra prediction image generation section 310 and the signal value of the decoded residual signal inputted from the inverse quantization and inverse DCT section 311. The addition section 312 stores the reference picture block thus generated in the reference picture memory 306 and externally outputs a decoded layer image Td obtained by integrating, for each picture, the reference picture block thus generated.

### (Configuration of Inter Prediction Parameter Decoding Section)

Next, a configuration of the inter prediction parameter decoding section 303 is described.

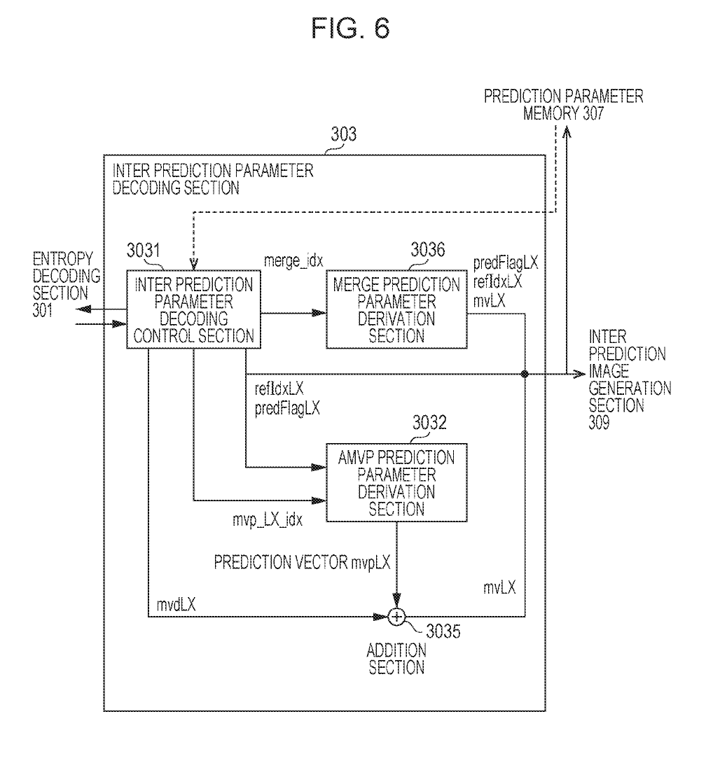

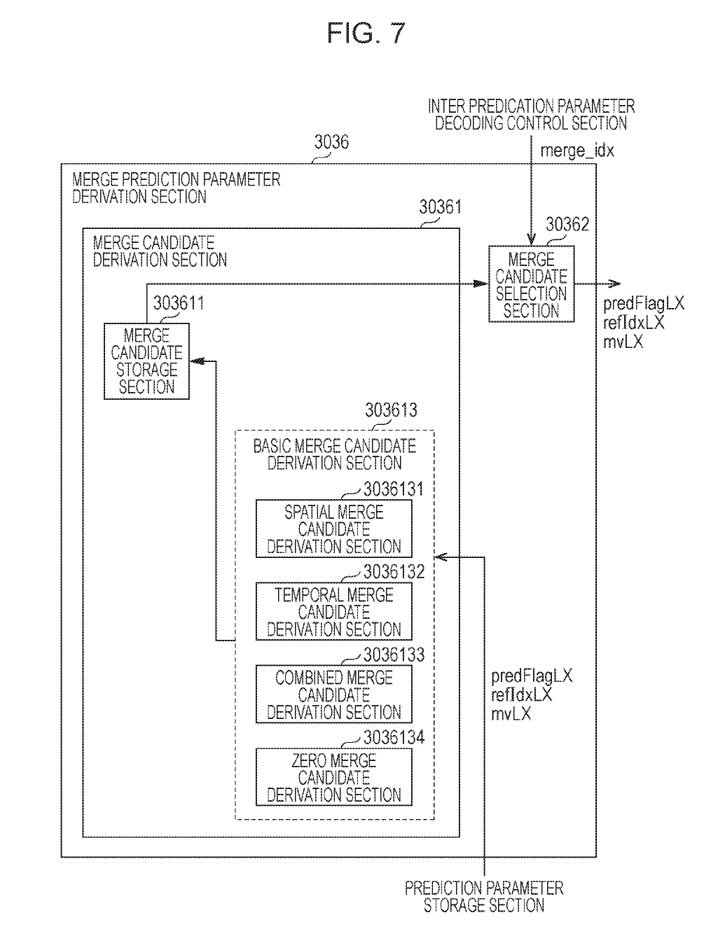

FIG. 6 is a schematic view showing the configuration of the inter prediction parameter decoding section 303 according to the present embodiment. The inter prediction parameter decoding section 303 includes an inter prediction parameter decoding control section 3031, an AMVP prediction parameter derivation section 3032, an addition section 3035, and a merge prediction parameter derivation section 3036.

The inter prediction parameter decoding control section 3031 instructs the entropy decoding section 301 to decode codes (syntax elements) associated with an inter prediction and extracts codes (syntax elements) included in coded data such as a partition mode part_mode, a merge_flag merge_flag, a merge index merge_idx, an inter prediction flag inter_pred_idc, a reference picture index refIdxLX, a prediction vector index mvp_LX_idx, and a difference vector mvdLX.

The expression “the inter prediction parameter decoding control section 3031 extracts a syntax element” means that the inter prediction parameter decoding control section 3031 instructs the entropy decoding section 301 to decode a syntax element and reads out the syntax element from the coded data. Note here that in a case where the merge flag indicates a value of 1, i.e. a merge prediction mode, the inter prediction parameter decoding control section 3031 extracts the merge index merge_idx as a prediction parameter pertaining to a merge prediction. The inter prediction parameter decoding control section 3031 outputs the merge index merge_idx thus extracted to the merge prediction parameter derivation section 3036.

In a case where the merge flag merge_flag indicates 0, i.e. an AMVP prediction mode, the inter prediction parameter decoding control section 3031 extracts an AMVP prediction parameter from the coded data through the entropy decoding section 301. Examples of the AMVP prediction parameter include the inter prediction flag inter_pred_idc, the reference picture index refIdxLX, the vector index mvp_LX_idx, the difference vector mvdLX. The inter prediction parameter decoding control section 3031 outputs a prediction list utilization flag predFlagLX derived from the inter prediction flag inter_pred_idc thus extracted and the reference picture index refIdxLX thus extracted to the AMVP prediction parameter derivation section 3032 and the predicted image generation section 308 (FIG. 5) and stores them in the prediction parameter memory 307 (FIG. 5). The inter prediction parameter decoding control section 3031 outputs the vector index mvp_LX_idx thus extracted to the AMVP prediction parameter derivation section 3032. The inter prediction parameter decoding control section 3031 outputs the difference vector mvdLX thus extracted to the addition section 3035.

FIG. 7 is a schematic view showing a configuration of the merge prediction parameter derivation section 3036 according to the present embodiment. The merge prediction parameter derivation section 3036 includes a merge candidate derivation section 30361 and a merge candidate selection section 30362. A merge candidate storage section 303611 stores a merge candidate inputted from the merge candidate derivation section 30361. It should be noted that a merge candidate includes a prediction list utilization flag predFlagLX, a vector mvLX, and a reference picture index refIdxLX. A merge candidate stored in the merge candidate storage section 303611 is assigned an index according to a predetermined rule. The merge candidate derivation section 30361 includes a spatial merge candidate derivation section 3036131, a temporal merge candidate derivation section 3036132, a combined merge candidate derivation section 3036133, and a zero merge candidate derivation section 3036134.

The spatial merge candidate derivation section 3036131 reads out, according to a predetermined rule, prediction parameters (a prediction list utilization flag predFlagLX, a vector mvLX, and a reference picture index refIdxLX) stored in the prediction parameter memory 307 and derives, as a merge candidate, the prediction parameters thus read out. The prediction parameters to be read out are prediction parameters pertaining to each of the blocks falling within a predetermined range from the decoding target block (e.g. all or some of the blocks adjoining the lower left edge, upper left edge, and the upper right edge, respectively, of the decoding target block). The merge candidate thus derived is stored in the merge candidate storage section 303611.

The temporal merge candidate derivation section 3036132 reads out as a merge candidate from the prediction parameter memory 307 the prediction parameters of a block in a reference image including the lower right coordinates of the decoding target block. The reference image may for example be designated by a reference picture index refIdxLX designated by being placed in a slice header or may be designated with use of the smallest one of the reference picture indices refIdxLX of the blocks neighboring the decoding target block. The merge candidate thus derived is stored in the merge candidate storage section 303611.

The combined merge candidate derivation section 3036133 derives a combined merge by combining, as the vectors of L0 and L1, the vectors and reference picture indices of two different derived merge candidates already stored in the merge candidate storage section 303611, respectively. The merge candidate thus derived is stored in the merge candidate storage section 303611.

The zero merge candidate derivation section 3036134 derives a merge candidate whose reference picture index refIdxLX is 0 and the X and Y components of whose vector mvLX are both 0. The merge candidate thus derived is stored in the merge candidate storage section 303611.

From among the merge candidates stored in the merge candidate storage section 303611, the merge candidate selection section 30362 selects, as the inter prediction parameters of the target PU, a merge candidate assigned an index corresponding to the merge index merge_idx inputted from the inter prediction parameter decoding control section 3031. The merge candidate selection section 30362 stores the merge candidate thus selected in the prediction parameter memory 307 (FIG. 5) and outputs it to the predicted image generation section 308 (FIG. 5).

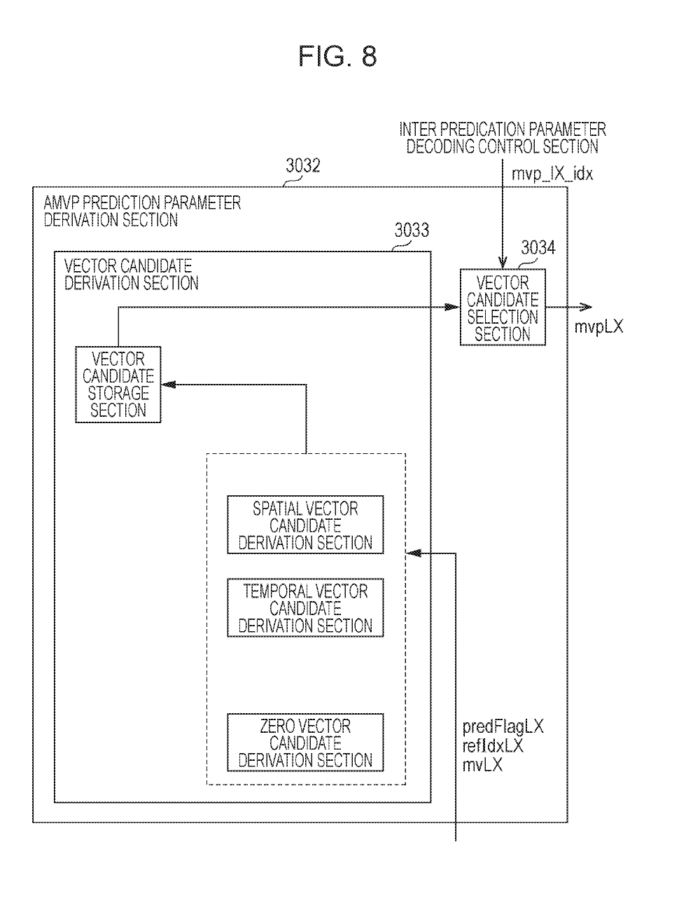

FIG. 8 is a schematic view showing a configuration of the AMVP prediction parameter derivation section 3032 according to the present embodiment. The AMVP prediction parameter derivation section 3032 includes a vector candidate derivation section 3033 and a prediction vector selection section 3034. On the basis of a reference picture index refIdx, the vector candidate derivation section 3033 reads out, as vector candidates mvpLX, vectors (motion vectors or disparity vectors) stored in the prediction parameter memory 307 (FIG. 5). The vector to be read out are vectors pertaining to each of the blocks falling within a predetermined range from the decoding target block (e.g. all or some of the blocks adjoining the lower left edge, upper left edge, and the upper right edge, respectively, of the decoding target block).

From among the vector candidates read out by the vector candidate derivation section 3033, the prediction vector selection section 3034 selects, as a prediction vector mvpLX, a vector candidate indicated by the vector index mvp_LX_idx inputted from the inter prediction parameter decoding control section 3031. The prediction vector selection section 3034 outputs the prediction vector mvpLX thus selected to the addition section 3035.

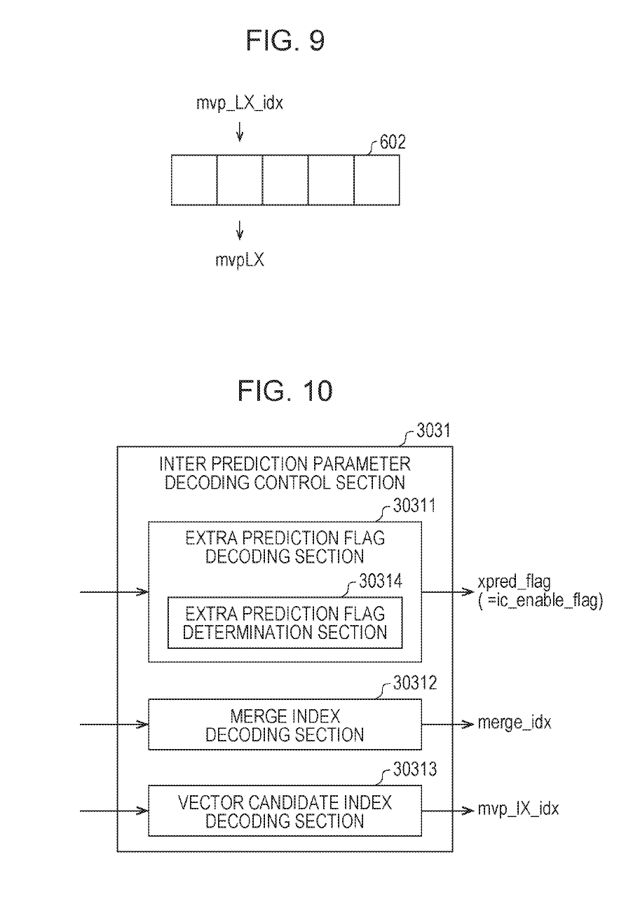

FIG. 9 is a conceptual diagram showing examples of vector candidates. FIG. 9 shows a prediction vector list 602, which is a list of a plurality of vector candidates that are derived by the vector candidate derivation section 3033. In the prediction vector list 602, the five rectangles arranged in a row from side to side indicate regions indicating prediction vectors, respectively. The downward arrow directly below the second mvp_LX_idx from the left edge and mvpLX therebelow indicate that the vector index mvp_LX_idx is an index that refers to the vector mvpLX in the prediction parameter memory 307.

Candidate vectors are blocks finished with a decoding process, refer to blocks (e.g. neighboring blocks) falling within a predetermined range from the decoding target block, and are generated on the basis of vectors pertaining to the blocks thus referred to. It should be noted that the neighboring blocks include blocks spatially neighboring the target block, such as a left block and an upper block, and blocks temporally neighboring the target block, such as blocks obtained from blocks that are identical in position to but different in display time from the target block.

The addition section 3035 computes a vector mvLX by adding a prediction vector mvpLX inputted from the prediction vector selection section 3034 and a difference vector mvdLX inputted from the inter prediction parameter decoding control section. The addition section 3035 outputs the vector mvLX thus computed to the predicted image generation section 308 (FIG. 5).

FIG. 10 is a diagram showing a configuration of the inter prediction parameter decoding control section 3031. The inter prediction parameter decoding control section 3031 includes an extra prediction flag decoding section 30311, a merge index decoding section 30312, a vector candidate index decoding section 30313, a partition mode decoding section (not illustrated), a merge flag decoding section (not illustrated), an inter prediction flag decoding section (not illustrated), a reference picture index decoding section (not illustrated), and a vector difference decoding section (not illustrated). The partition mode decoding section, the merge flag decoding section, the merge index decoding section, the inter prediction flag decoding section, the reference picture index decoding section, the vector candidate index decoding section 30313, and the vector difference decoding section decode a partition mode part_mode, a merge_flag merge_flag, a merge index merge_idx, an inter prediction flag inter_pred_idc, a reference picture index refIdxLX, a prediction vector index mvp_LX_idx, and a difference vector mvdLX, respectively.

The extra prediction flag decoding section 30311 decodes a flag ic_enable_flag indicating whether to make an illuminance prediction, which is an extra prediction, and outputs it to the inter prediction image generation section 309.

In a case where a block neighboring the target PU has a disparity vector, a disparity vector acquisition section extracts the disparity vector from the prediction parameter memory 307, refers to the prediction parameter memory 307, and reads out the prediction flag predFlagLX, reference picture index refIdxLX, and vector mvLX of the block neighboring the target PU.

(Inter Prediction Image Generation Section 309)

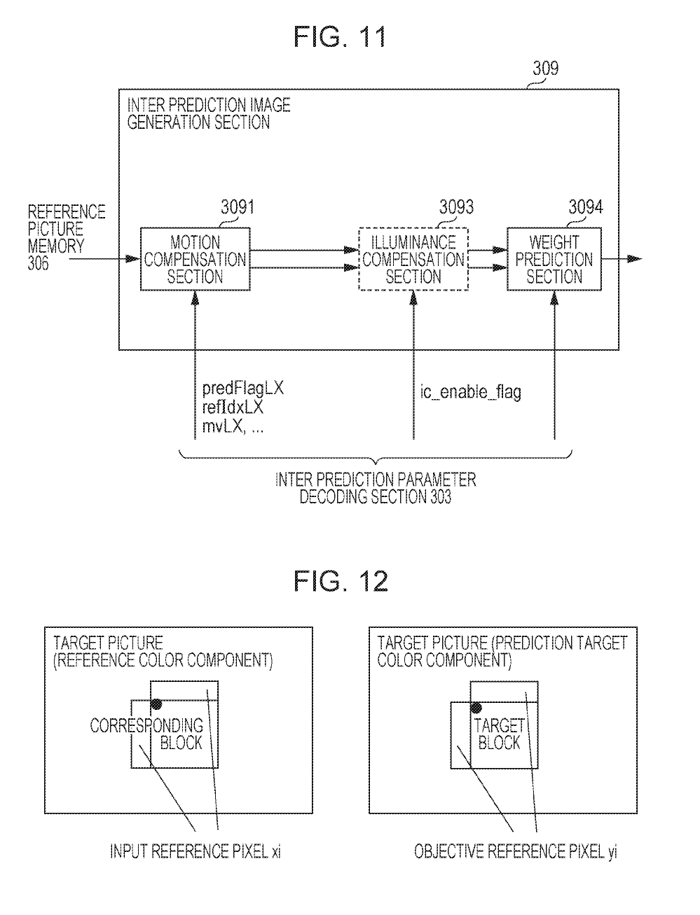

FIG. 11 is a schematic view showing a configuration of the inter prediction image generation section 309 according to the present embodiment. The inter prediction image generation section 309 includes a motion compensation section 3091, an illuminance compensation section 3093, and a weight prediction section 3094.

(Motion Compensation)

The motion compensation section 3091 generates a motion-compensated image by reading out, from the reference picture memory 306 on the basis of a prediction list utilization flag predFlagLX, a reference picture index refIdxLX, and a motion vector mvLX inputted from the inter prediction parameter decoding section 303, a block located in a position displaced by the vector mvLX starting from the position of the target block of a reference picture designated by the reference picture index refIdxLX. Note here that in a case where the vector mvLX is not an integer vector, the motion-compensated image is generated by applying a filter called “motion-compensation filter (or disparity-compensation filter)” for generating pixels in decimal positions. In general, although there is a case where the process is called “motion compensation” only in a case where the vector mvLX is a motion vector and called “disparity compensation” in a case where the vector mvLX is a disparity vector, the simple expression “motion compensation” is used herein without distinction of type of vector. In the following, a motion-compensated image of a L0 prediction is called “predSamplesL0” and a motion-compensated image of a L1 prediction is called “predSamplesL1” In a case where no distinction is made between them, they are called “predSamplesLX”. The following describes an example in which illuminance compensation is further made for motion-compensated images predSamplesLX obtained by the motion compensation section 3091, and these output images are also called “motion-compensated images predSamplesLX”. It should be noted that in a case of making distinction between an input image and an output image in the following illuminance compensation, the input image is expressed as “predSamplesLX” and the output image is expressed as “predSamplesLX′”.

(Illuminance Compensation)

In a case where an illuminance compensation flag ic_enable_flag is 1, the illuminance compensation section 3093 makes illuminance compensation for a motion disparity image predSamplesLX inputted thereto. In a case where the illuminance compensation flag ic_enable_flag is 0, the illuminance compensation section 3093 directly outputs a motion-compensated image predSamplesLX inputted thereto. A motion-compensated image predSamplesLX that is inputted to the illuminance compensation section 3093 is an output image of the motion compensation section 3091. Illuminance compensation is made on the basis of the assumption that a change between the pixel values of a motion-compensated image in a neighboring region neighboring the target block for which a predicted image is generated and a decoded image of the neighboring region is similar to a change between the pixel values within the target block and the original image of the target block.

An illuminance parameter estimation section 30931 calculates an estimated parameter for estimating the pixels of a target block (target prediction unit) from the pixels of a reference block. FIG. 13 is a diagram for explaining illuminance compensation. FIG. 13 shows the positions of pixels (objective reference pixels) around the target block and the positions of pixels (input reference pixels) around a reference block on a reference layer image that are located in positions displaced by a certain vector from the target block.

The illuminance parameter estimation section 30931 calculates an estimated parameter (illuminance change parameter) from the objective reference pixels y (y0 to yN−1) around the target block and the input reference pixels x (x0 to xN−1) around the reference block.

(Illuminance Compensation Section 3093)

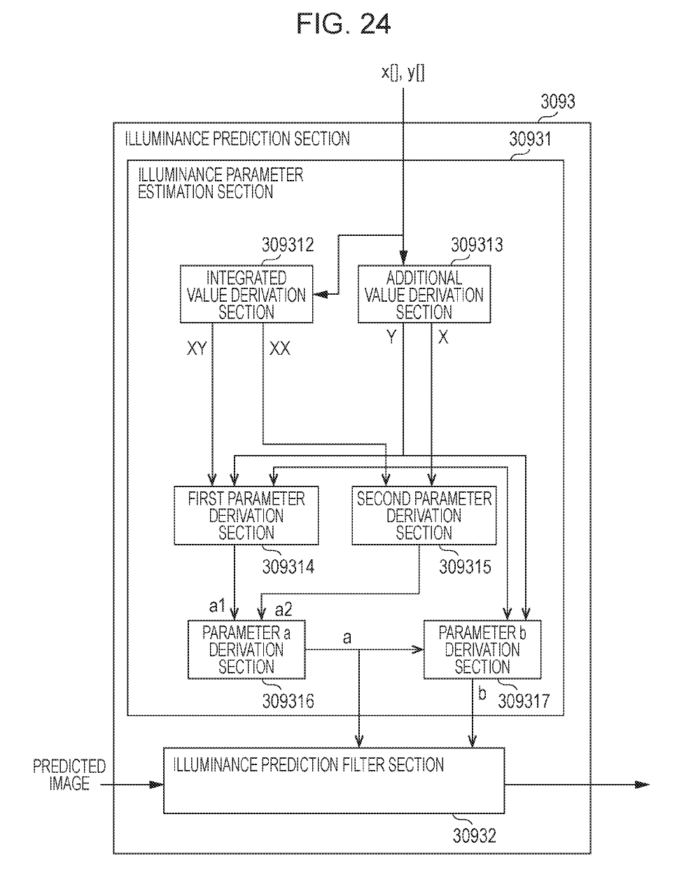

FIG. 24 is a block diagram showing a configuration of the illuminance compensation section 3093. The illuminance compensation section 3093 includes the illuminance parameter estimation section 30931 and an illuminance compensation filter section 30932. The illuminance parameter estimation section 30931 includes an integrated shift value derivation section 309311, an integrated value derivation section 309312, an additional value derivation section 309313, a first parameter derivation section 309314, a second parameter derivation section 309315, a parameter a derivation section 309316, a parameter b derivation section 309317, and a regularization cost addition section 309318.

With the input reference pixels x[ ] being pixels C around the reference block on the reference layer image shown in FIG. 13 and the objective reference pixels y[ ] being pixels L around the target block, the illuminance parameter estimation section 30931 derives the parameters a and b, which are parameters in a case of linearly predicting the objective reference pixels y[ ] from the input reference pixels x[ ], on the basis of the input reference pixels x[ ] and the objective reference pixels y[ ].

The additional value derivation section 309313 derives the sum Y of objective reference pixels y and the sum X of input reference pixels x according to the following Formulae (B-2) and (B-3).

The integrated value derivation section 309312 derives the sum XY of the products of the objective reference pixels y and the input reference pixels x and the sum XX of the squares of the objective reference pixels x according to the following Formulae (B-4) and (B-5). At this time, the integrated value derivation section 309312 derives the sum XY of the products of the objective reference pixels y and the input reference pixels x and the sum XX of the squares of the input reference pixels x. X, Y, XY, and XX are zero-initialized prior to the following summations.

X=Σx[i*2] Formula (B-2)

Y=Σy[i*2] Formula (B-3)

XX=Σ(x[i]*x[i]) Formula (B-4)

XY=Σ(x[i]*y[i]) Formula (B-5)

Note here that Σ is the sum with respect to a reference region and a sum with respect to an index i specifying pixels of the reference region is derived. y[i] is the pixel value of a decoded image in the index i. x[i] is the pixel value of a reference image in the index i. The count shift value iCountShift is the logarithm of 2 of the size of the reference region.

iCountShift=log 2 (Number of pixels of reference region) Formula (B-6)

The first parameter derivation section 309314 derives the first parameter a1 according to the following formula on the basis of the difference between the sum XY of the products of the objective reference pixels y and the input reference pixels x and the product of the sum Y of the objective reference pixels and the sum X of the input reference pixels.

a1=(XY<<iCountShift)−(Y*X) Formula (B-7)

As indicated by Formula (B-7), the difference is computed after XY has been shifted leftward by the count shift value iCountShift.

The second parameter derivation section 309315 derives the second parameter a2 according to the following formula from the difference between the sum XX of the squares of the input reference pixels x and the square of the sum X of the input reference pixels x.

a2=(XX<<iCountShift)−(X*X); Formula (B-8)

As indicated by Formula (B-8), the difference is computed after XX has been shifted leftward by the count shift value iCountShift.

The first parameter a1 and the second parameter a2 thus derived are outputted to the parameter a derivation section 309316.

The first parameter derivation section 309314 restricts the first parameter a1 according to the magnitude of the second parameter a2. For example, a1 is clipped to not less than 0 and not greater than double a2 as indicated by the following formula.

a1=Clip3(0,2*a2,a1) Formula (B-12)

The first parameter derivation section 309314 clips the value of a1/a2 between 0 to 2. Accordingly, the value of a1/a2<<iShift, which is the value of the parameter a, is also clipped to 0 to 2<<iShift. That is, in a case where iShift=6, the parameter a becomes 0 to 128 and falls within a range of 8-bit non-negative integers.

For a predetermined bit width ShiftA2 used in the derivation of the table of FIG. 16, the first parameter derivation section 309314 derives a second normalization shift value iScaleShiftA2 according to the following formula depending on the magnitude of the second parameter a2. The second normalization shift value iScaleShiftA2 thus derived is outputted to a table base parameter a derivation section 3093163.

iScaleShiftA2=Max(0,Floor(Log 2(Abs(a2)))−(ShiftA2−1)) Formula (B-14)

A first parameter normalization shift section 3093161 derives a first normalization shift value iScaleShiftA1 according to the following formula depending on the second normalization shift value iScaleShiftA2. The first normalization shift value iScaleShiftA1 thus derived is outputted to the table base parameter a derivation section 3093163.

iScaleShiftA1=Max(0,iScaleShiftA2−offsetA1) Formula (B-13)

It should be noted that offsetA1 is here a constant that satisfies not greater than 10.

In the foregoing, the derivation of the first normalization shift value with use of the second normalization shift value brings about an effect of facilitating a process of deriving a first normalization parameter.

The first parameter derivation section 309314 and the second parameter derivation section 309315 derive a normalized first parameter a1s and a normalized second parameter a2s by shifting the first parameter a1 and the second parameter a2 rightward by the first normalization shift value iScaleShiftA1 and the second normalization shift value iScaleShiftA2, respectively.

a1s=a1>>iScaleShiftA1 Formula (B-15)

a2s=a2>>iScaleShiftA2 Formula (B-16)

This allows the normalized first parameter a1s and the normalized second parameter a2s to be normalized to be values between 0 and the iShiftA1th power of 2-1 and between 0 and the ShiftA2th power of 2-1, respectively.

The parameter a derivation section 309316 derives a parameter a shift value iScaleShiftA according to the following formula on the basis of the difference between the first normalization shift value iScaleShiftA1 and the second normalization shift value iScaleShiftA2.

ScaleShiftA=ShiftA1+iScaleShiftA2−iScaleShiftA1−iShift Formula (B-18)

Note here since iScaleShiftA1=Max(0, iScaleShiftA2−offsetA1), the following formula holds:

ScaleShiftA<=ShiftA1+iScaleShiftA2−(iScaleShiftA2−offsetA1)−iShift

ScaleShiftA<=ShiftA1+offsetA1−iShift

Since offsetA1 is not less than 0, iShift ranges from 5 to 8 bits, and ShiftA1 ranges from 14 bits to 15 bits, ScaleShiftA is always not less than 0.

The parameter a derivation section 309316 derives the parameter a according to the following formula by referring to an inverse table value invTable that is determined according to the normalized second parameter a2s, calculating the product of the inverse table value invTable and the normalized first parameter a1s, and shifting the product rightward by a table shift value (ScaleShiftA).

a=(a1s*invTable[a2s])>>(ScaleShiftA) Formula (B-19)

FIG. 16 is an inverse table value invTable[ ] that is used in the present embodiment. As previously mentioned, the inverse invTable[x] of FIG. 16 becomes 0 in a case where the index x is 0 and, in a case where the index x is not 0, is derived from an integer value obtained by dividing a predetermined constant (here, the fifteenth power of 2) M by x.

The parameter a thus derived is outputted to the parameter b derivation section 309317 and the illuminance compensation filter section 30932.

The parameter b derivation section 309317 derives the parameter b according to the following formula by dividing, by the number of pixels of the reference region, a value obtained by subtracting, from the sum Y of the objective reference pixels, a value obtained by multiplying the sum X of the input reference pixels by the parameter a and shifting the product by a fixed shift value iShift.

b=(Y−((a*X)>>iShift)+(1<<(iCountShift−1)))>>iCountShift Formula (B-20)

It should be noted that the right shift of iCountShift is equivalent to dividing the value by the number of pixels of the reference region.

The illuminance compensation filter section 30932 derives a predicted image after illuminance compensation predSamples′[ ] from a predicted image before illuminance compensation predSamples[ ] with use of the estimated parameter derived by the illuminance parameter estimation section 30931. For example, in a case of deriving the parameter b according to Formula (B-20), the following formula is used.

predSamples′[x][y]=(a*predSamples[x][y]>>iShift)+b Formula (B-21)

(Weight Prediction)

The weight prediction section 3094 generates a predicted picture block P (predicted image) by multiplying a motion disparity image predSamplesLX inputted thereto by a weight coefficient. In a case where a residual prediction and illuminance compensation are made, the motion disparity image predSamplesLX inputted thereto is an image to which they are applied. In a case where either of the reference list utilization flags (predFlagL0 or predFlagL1) is 1 (in the case of a uni-prediction) and a weight prediction is not used, the following formula is processed so that the inputted motion disparity image predSamplesLX (where LX is L0 or L1) is fitted to the number of pixel bits.

predSamples[x][y]=Clip3(0,(1<<bitDepth)−1,(predSamplesLX[x][y]+offset1)>>shift1)

Note here that shift1=14−bitDepth and offset1=1>>(shift1−1).

Further, in a case where both of the reference list utilization flags (predFlagL0 or predFlagL1) are 1 (in the case of a bi-prediction) and a weight prediction is not used, the following formula is processed so that the inputted motion disparity images predSamplesL0 and predSamplesL1 are averaged and fitted to the number of pixel bits.

predSamples[x][y]=Clip3(0,(1<<bitDepth)−1,(predSamplesL0[x][y]+predSamplesL1[x][y]+offset2)>>shift2)

Note here that shift2=15−bitDepth and offset2=1<<(shift2−1).

Furthermore, in a case of making a weight prediction in the case of a uni-prediction, the weight prediction section 3094 derives a weight prediction coefficient w0 and an offset o0 and processes the following formula:

predSamples[x][y]=Clip3(0,(1<<bitDepth)−1,((predSamplesLX[x][y]w0+2 log 2W0−1)>>log 2WD)+o0)

Note here that log 2WD is a variable that indicates a predetermined shift amount.

Furthermore, in a case of making a weight prediction in the case of a bi-prediction, the weight prediction section 3094 derives weight prediction coefficients w0, w1, o0, and o1 and processes the following formula:

predSamples[x][y]=Clip3(0,(1>>bitDepth)−1,(predSamplesL0[x][y]*w0+predSamplesL1[x][y]*w1+((o0+o1+1)>> log 2WD))>>(log 2WD+1))

(Configuration of Image Encoding Device)

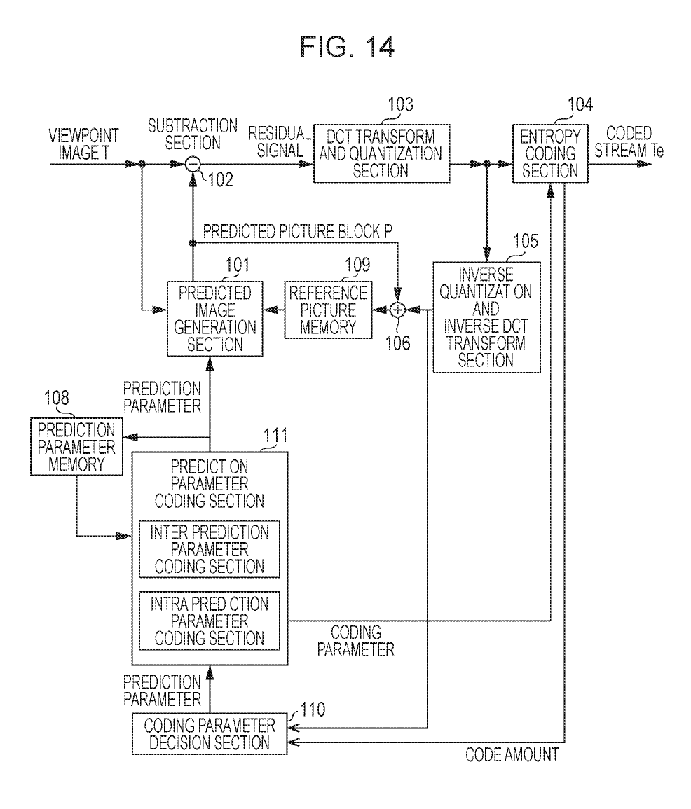

Next, a configuration of the image encoding device 11 according to the present embodiment is described. FIG. 14 is a block diagram showing the configuration of the image encoding device 11 according to the present embodiment. The image encoding device 11 includes a predicted image generation section 101, a subtraction section 102, a DCT and quantization section 103, an entropy coding section 104, an inverse quantization and inverse DCT section 105, an addition section 106, a prediction parameter memory (prediction parameter storage section, frame memory) 108, a reference picture memory (reference picture storage section, frame memory) 109, a coding parameter decision section 110, a prediction parameter coding section 111, and a residual storage section 313 (residual recording section). The prediction parameter coding section 111 includes an inter prediction parameter coding section 112 and an intra prediction parameter coding section 113.

The predicted image generation section 101 generates a predicted picture block P for each block that is a region into which a picture for each viewpoint of a layer image T inputted from an outside source has been partitioned. Note here that the predicted image generation section 101 reads out a reference picture block from the reference picture memory 109 on the basis of a prediction parameter inputted from the prediction parameter coding section 111. The prediction parameter inputted from the prediction parameter coding section 111 is for example a motion vector or a disparity vector. The predicted image generation section 101 reads out the reference picture block of a block located in a position indicated by a motion vector or disparity vector predicted with the coding target block as a starting point. The predicted image generation section 101 generates a predicted picture block P with use of one of a plurality of prediction schemes for the reference picture block thus read out. The predicted image generation section 101 outputs the predicted picture block P thus generated to the subtraction section 102. It should be noted that since the predicted image generation section 101 is identical in operation to the already-described predicted image generation section 308, details of the generation of a predicted picture block P are omitted.

In selecting a prediction scheme, the predicted image generation section 101 selects a prediction scheme that minimizes an error value based on the difference between the signal value of each pixel of a block included in the layer image and the signal value of each corresponding pixel of the predicted picture block P. This is not the only method for selecting a prediction scheme.

In a case where the picture to be coded is a base layer picture (base view picture) that does not depend on another layer, the plurality of prediction schemes are an intra prediction, a motion prediction, and a merge prediction. A motion prediction is a prediction between display times among the aforementioned inter predictions. A merge prediction is a prediction that involves the use of the same reference picture block and prediction parameters as those of a block having already coded and falling within a predetermined range from the coding target block. In a case where the picture to be coded is a non-base view picture, the plurality of prediction schemes are an intra prediction, a motion prediction, a merge prediction, and a disparity prediction. A disparity prediction (parallax prediction) is a prediction between different layer images (different viewpoint images) among the aforementioned inter predictions. Furthermore, there are a motion prediction, a merge prediction, and a disparity prediction. There are a prediction in a case where an extra prediction (illuminance compensation) is made and a prediction in a case where an extra prediction (illuminance compensation) is not made.

In a case of having selected an intra prediction, the predicted image generation section 101 outputs, to the prediction parameter coding section 111, a prediction mode predMode indicating an intra prediction mode used in generating the predicted picture block P.

In a case of having selected a motion prediction, the predicted image generation section 101 stores, in the prediction parameter memory 108, a motion vector mvLX used in generating the predicted picture block P and outputs the motion vector mvLX to the inter prediction parameter coding section 112. The motion vector mvLX indicates a vector from the position of the coding target block to the position of a reference picture block with reference to which the predicted picture block P is generated. Information indicating the motion vector mvLX may include information indicating a reference picture (e.g. a reference picture index refIdxLX and a picture order count POC) and express a prediction parameter. Further, the predicted image generation section 101 outputs, to the prediction parameter coding section 111, a prediction mode predMode indicating an inter prediction mode.

In a case of having selected a disparity prediction, the predicted image generation section 101 stores, in the prediction parameter memory 108, a disparity vector used in generating the predicted picture block P and outputs the disparity vector to the inter prediction parameter coding section 112. The disparity vector dvLX indicates a vector from the position of the coding target block to the position of a reference picture block with reference to which the predicted picture block P is generated. Information indicating the disparity vector dvLX may include information indicating a reference picture (e.g. a reference picture index refIdxLX and a view ID view_id) and represent a prediction parameter. Further, the predicted image generation section 101 outputs, to the prediction parameter coding section 111, a prediction mode predMode indicating an inter prediction mode.

In a case of having selected a merge prediction, the predicted image generation section 101 outputs, to the inter prediction parameter coding section 112, a merge index merge_idx indicating the selected reference picture block. Further, the predicted image generation section 101 outputs, to the prediction parameter coding section 111, a prediction mode predMode indicating a merge prediction mode.

In the foregoing motion prediction, disparity prediction, and merge prediction, the predicted image generation section 101 makes a residual prediction through a residual prediction section 3092 of the predicted image generation section 101 as previously mentioned in a case where the residual prediction flag res_pred_flag indicates making a residual prediction and makes an illuminance compensation prediction through the illuminance compensation section 3093 of the predicted image generation section 101 as previously mentioned in a case where the illuminance compensation flag ic_enable_flag indicates making illuminance compensation.

The subtraction section 102 generates a residual signal by subtracting the signal value of the predicted picture block P, inputted from the predicted image generation section 101, from the signal value of the corresponding block of the layer image T, inputted from an outside source, for each pixel. The subtraction section 102 outputs the residual signal thus generated to the DCT and quantization section 103 and the coding parameter decision section 110.

The DCT and quantization section 103 computes a DCT coefficient by performing DCT on the residual signal inputted from the subtraction section 102. The DCT and quantization section 103 calculates a quantized coefficient by quantizing the DCT coefficient thus computed. The DCT and quantization section 103 outputs the quantized coefficient thus calculated to the entropy coding section 104 and the inverse quantization and inverse DCT section 105.

The entropy coding section 104 receives the quantized coefficient from the DCT and quantization section 103 and receives coding parameters from the coding parameter decision section 110. Examples of the coding parameters to be received include codes such as a reference picture index refIdxLX, a vector index mvp_LX_idx, a difference vector mvdLX, a prediction mode predMode, and a merge index merge_idx.

The entropy coding section 104 generates a coded stream Te by entropy-coding the quantized coefficient and coding parameters thus received and externally outputs the coded stream Te thus generated.

The inverse quantization and inverse DCT section 105 calculates a DCT coefficient by inversely quantizing the quantized coefficient inputted from the DCT and quantization section 103. The inverse quantization and inverse DCT section 105 computes a decoded residual signal by performing inverse DCT on the DCT coefficient thus calculated. The inverse quantization and inverse DCT section 105 outputs the decoded residual signal thus computed to the addition section 106.

The addition section 106 generates a reference picture block by adding the signal value of the predicted picture block P, inputted from the predicted image generation section 101, and the signal value of the decoded residual signal, inputted from the inverse quantization and inverse DCT section 105, for each pixel. The addition section 106 stores the reference picture block thus generated in the reference picture memory 109.

The prediction parameter memory 108 stores, in a location determined in advance for each picture and block to be coded, prediction parameters generated by the prediction parameter coding section 111.

The reference picture memory 109 stores, in a location determined in advance for each picture and block to be coded, a reference picture block generated by the addition section 106.

The coding parameter decision section 110 selects one set from among a plurality of sets of coding parameters. Coding parameters are the aforementioned prediction parameters and parameters to be coded that are generated in association with these prediction parameters. The predicted image generation section 101 generates a predicted picture block P with use of each of these sets of coding parameters.

The coding parameter decision section 110 computes a cost value indicating the magnitude of the amount of information and a coding error for each of the plurality of sets. The cost value is for example the sum of a code amount and a value obtained by multiplying a square error by a coefficient λ. The code amount is the amount of information of a coded stream Te that is obtained by entropy-coding a quantization error and a coding parameter. The square error is the inter-pixel total sum of the square values of the residual values of residual signals computed by the subtraction section 102. The coefficient λ is a preset real number of larger than 0. The coding parameter decision section 110 selects such a set of coding parameters that the cost value thus computed is minimized. This allows the entropy coding section 104 to externally outputs the selected set of coding parameters as the coded stream Te and prevents the entropy coding section 104 from outputting an unselected set of coding parameters.

The prediction parameter coding section 111 derives prediction parameters that are used in generating a predicted picture on the basis of the parameters inputted from the predicted image generation section 101 and generates a set of coding parameters by coding the predicted parameters thus derived. The prediction parameter coding section 111 outputs the set of coding parameters thus generated to the entropy coding section 104.

The prediction parameter coding section 111 stores, in the prediction parameter memory 108, those prediction parameters of the set of coding parameters thus generated which correspond to those selected by the coding parameter decision section 110.

In a case where the prediction mode predMode inputted from the predicted image generation section 101 indicates an inter prediction mode, the prediction parameter coding section 111 actuates the inter prediction parameter coding section 112. In a case where the prediction mode predMode indicates an intra prediction mode, the prediction parameter coding section 111 actuates the intra prediction parameter coding section 113.

The inter prediction parameter coding section 112 derives inter prediction parameters on the basis of the prediction parameters inputted from the coding parameter decision section 110. The inter prediction parameter coding section 112 includes, as a configuration for deriving inter prediction parameters, the same configuration as that in which the inter prediction parameter decoding section 303 (see FIG. 5 and the like) derives inter prediction parameters. A configuration of the inter prediction parameter coding section 112 will be described later.

The intra prediction parameter coding section 113 defines, as a set of inter prediction parameters, the intra prediction mode IntraPredMode indicated by the prediction mode predMode inputted from the coding parameter decision section 110.

(LM Prediction Section)

As with the predicted image generation section 308, the predicted image generation section 101 includes an LM prediction section 3104. As previously mentioned, the LM prediction section 3104 includes an LM parameter estimation section 31041 and is an image predicting device including: a linear prediction parameter derivation section that, with an input being sets of pixel values xi and pixel values yi corresponding to an index i, derives linear prediction parameters a and b for predicting yi from xi; and a linear prediction section that generates a predicted image on the basis of the linear prediction parameters, wherein the linear prediction parameter derivation section includes means for deriving the linear prediction parameter a from a first parameter a1 derived from the sum XY of the products of the pixel values xi and the pixel values yi and the product of the sum X of the pixel values xi and the sum Y of the pixel values yi and a second parameter a2 derived from the sum XX of the products of the pixel values xi and the pixel values xi and the product of the sum X of the pixel values xi and the sum X of the pixel values xi, and the linear prediction parameter derivation section includes at least one of means for comparing the first parameter a1 with a predetermined threshold THN and, in a case where the first parameter a1 is less than the threshold THN or not greater than the threshold THN, subtracting a first cost a1costN from the first parameter a1 and means for comparing the first parameter a1 with a predetermined threshold THP and, in a case where the first parameter a1 is less than the threshold THP or not greater than the threshold THP, adding a second cost a1costP to the first parameter a1.

By subtracting or adding a regularization cost on the basis of a comparison with a threshold so as to subtract the regularization cost a1costN from a1, for example, in a case where a1 is less than THN (here, THN=0), the LM parameter estimation section 31041 of the present configuration, which the predicted image generation section 101 includes, can bring the value of the parameter a close toward the farther side from 0 than a value that is derived by the method of least squares. The foregoing configuration allows the LM parameter estimation section 31041 to derive linear prediction parameters having resistance to noise, thus bringing about an effect of improving the prediction accuracy with which a predicted image is generated.

(Configuration of Inter Prediction Parameter Coding Section)

Next, a configuration of the inter prediction parameter coding section 112 is described. The inter prediction parameter coding section 112 is means that corresponds to the inter prediction parameter decoding section 303.

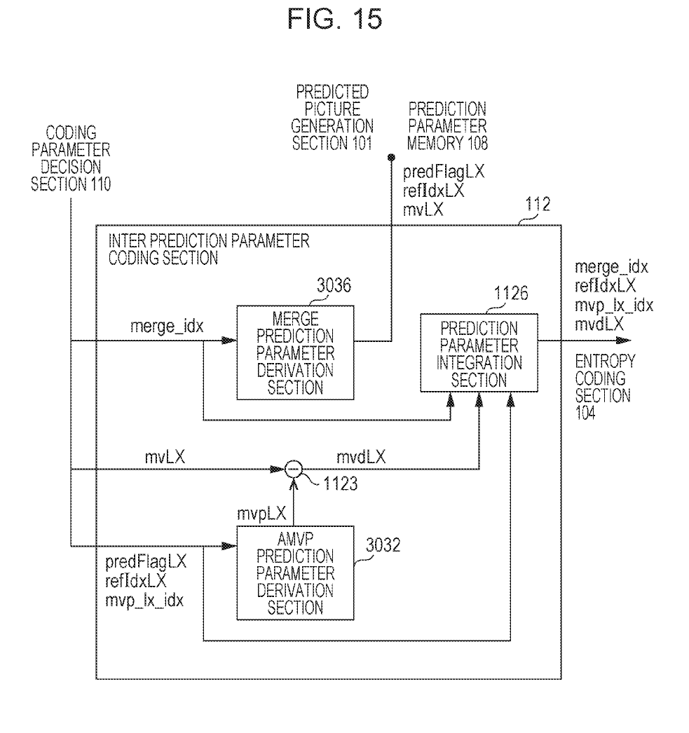

FIG. 15 is a schematic view showing a configuration of the inter prediction parameter coding section 112 according to the present embodiment.

The inter prediction parameter coding section 112 includes an inter prediction parameter coding control section 1031 (not illustrated), a merge prediction parameter derivation section 3036, an AMVP prediction parameter derivation section 3032, a subtraction section 1123, and a prediction parameter integration section 1126.

The merge prediction parameter derivation section 3036 has a configuration which is similar to that of the aforementioned merge prediction parameter derivation section 3036 (see FIG. 7).

The inter prediction parameter coding control section 1031 instructs the entropy coding section 104 to decode codes (syntax elements) associated with an inter prediction and codes codes (syntax elements) included in coded data such as a partition mode part_mode, a merge flag merge_flag, a merge index merge_idx, an inter prediction flag inter_pred_idc, a reference picture index refIdxLX, a prediction vector index mvp_LX_idx, and a difference vector mvdLX.

The inter prediction parameter coding control section 1031 includes an extra prediction flag coding section 10311, a merge index coding section 10312, a vector candidate index coding section 10313, a partition mode coding section (not illustrated), a merge flag coding section (not illustrated), an inter prediction flag coding section (not illustrated), a reference picture index coding section (not illustrated), and a vector difference coding section (not illustrated). The partition mode coding section, the merge flag coding section, the merge index coding section, the inter prediction flag coding section, the reference picture index coding section, the vector candidate index coding section 10313, and the vector difference coding section code a partition mode part_mode, a merge flag merge_flag, a merge index merge_idx, an inter prediction flag inter_pred_idc, a reference picture index refIdxLX, a prediction vector index mvp_LX_idx, and a difference vector mvdLX, respectively.

The extra prediction flag coding section 10311 codes an illuminance compensation flag ic_enable_flag in order to indicate whether an extra prediction is made.

In a case where the prediction mode predMode inputted from the predicted image generation section 101 indicates a merge prediction mode, the merge prediction parameter derivation section 3036 receives a merge index merge_idx from the coding parameter decision section 110. The merge index merge_idx is outputted to the prediction parameter integration section 1126. The merge prediction parameter derivation section 3036 reads out the reference picture index refIdxLX and vector mvLX of a reference block indicated by the merge index merge_idx among the merge candidates from the prediction parameter memory 108. The merge candidates are reference blocks finished with a coding process that fall within a predetermined range from the coding target block to be coded (e.g. among the reference blocks adjoining the lower left edge, upper left edge, and the upper right edge of the coding target block).

The AMVP prediction parameter derivation section 3032 has a configuration which is similar to that of the aforementioned AMVP prediction parameter derivation section 3032 (see FIG. 8).

In a case where the predMode inputted from the predicted image generation section 101 indicates an inter prediction mode, the AMVP prediction parameter derivation section 3032 receives a vector mvLX from the coding parameter decision section 110. The AMVP prediction parameter derivation section 3032 derives a prediction vector mvpLX on the basis of the vector mvLX thus received. The AMVP prediction parameter derivation section 3032 outputs the prediction vector mvpLX thus derived to the subtraction section 1123. It should be noted that the reference picture index refIdx and the vector index mvp_LX_idx are outputted to the prediction parameter integration section 1126.

The subtraction section 1123 generates a difference vector mvdLX by subtracting the prediction vector mvpLX inputted from the AMVP prediction parameter derivation section 3032 from the vector mvLX inputted from the coding parameter decision section 110. The difference vector mvdLX is outputted to the prediction parameter integration section 1126.

In a case where the prediction mode predMode inputted from the predicted image generation section 101 indicates a merge prediction mode, the prediction parameter integration section 1126 outputs, to the entropy coding section 104, the merge index merge_idx inputted from the coding parameter decision section 110.

In a case where the prediction mode predMode inputted from the predicted image generation section 101 indicates an inter prediction mode, the prediction parameter integration section 1126 performs the following process.

The prediction parameter integration section 1126 integrates the reference picture index refIdxLX and the vector index mvp_LX_idx inputted from the coding parameter decision section 110 and the difference vector mvdLX inputted from the subtraction section 1123. The prediction parameter integration section 1126 outputs the codes thus integrated to the entropy coding section 104.

It should be noted that parts of the image encoding device 11 and the image decoding device 31 according to the aforementioned embodiment, e.g. the entropy decoding section 301, the prediction parameter decoding section 302, the predicted image generation section 101, the DCT and quantization section 103, the entropy coding section 104, the inverse quantization and inverse DCT section 105, the coding parameter decision section 110, the prediction parameter coding section 111, the entropy decoding section 301, the prediction parameter decoding section 302, the predicted image generation section 308, and the inverse quantization and inverse DCT section 311, may be realized by a computer. In that case, a program for realizing these control functions may be stored in a computer-readable storage medium, and the program stored in this storage medium may be realized by being read into and executed by a computer system. It should be noted that the term “computer system” here means a computer system built in any of the image encoding devices 11 to 11h and the image decoding devices 31 to 31h and encompasses hardware such as an OS and a peripheral device. Further, the “computer-readable storage medium” refers to a portable medium such as a flexible disk, a magneto-optical disk, a ROM, or a CD-ROM and a storage device such as a hard disk built in the computer system. Furthermore, the “computer-readable storage medium” may encompass one that dynamically retains a program for a short time, such as a communication wire in a case of transmitting a program via a network such as the Internet or a communication line such as a telephone line, and one that retains a program for a certain period of time, such as a volatile memory inside a computer system serving as a server or a client in that case. Further, the program may be one that serves to realize some of the aforementioned functions or, furthermore, may be one that can realize the aforementioned functions in combination with a program already stored in the computer system.

Further, parts or all of the image encoding device 11 and the image decoding device 31 according to the aforementioned embodiment may be realized as an integrated circuit such as LSI (large-scale integration). Each functional block of the image encoding device 11 and the image decoding device 31 may be individually formed into processors, or some or all of them may be integrated to be formed into a processor. Further, the integrated circuit is not limited to being formed by LSI but may be realized by a dedicated circuit or a general-purpose processor. Further, in a case where the advancement of semiconductor technology brings about integrated-circuit technology that replaces LSI, an integrated circuit based on such technology may be used.

In the foregoing, an embodiment of the present invention has been described in detail with reference to the drawings. However, specific configurations are not limited to those described above, but various design changes and the like can be made without departing from the scope of the present invention.

According to an embodiment of the present invention, an image predicting device includes: a linear prediction parameter derivation section that, with an input being sets of pixel values xi and pixel values yi corresponding to an index i, derives linear prediction parameters a and b for predicting yi from xi; and a linear prediction section that generates a predicted image on the basis of the linear prediction parameters. The linear prediction parameter derivation section includes means for deriving the linear prediction parameter a from a first parameter a1 derived on the basis of the sum XY of the products of the pixel values xi and the pixel values yi and the product of the sum X of the pixel values xi and the sum Y of the pixel values yi and a second parameter a2 derived on the basis of the sum XX of the products of the pixel values xi and the pixel values xi and the product of the sum X of the pixel values xi and the sum X of the pixel values xi. The linear prediction parameter derivation section includes at least one of means for comparing the first parameter a1 with a predetermined threshold THN and, in a case where the first parameter a1 is less than the threshold THN or not greater than the threshold THN, subtracting a first cost a1costN from the first parameter a1 and means for comparing the first parameter a1 with a predetermined threshold THP and, in a case where the first parameter a1 is less than the threshold THP or not greater than the threshold THP, adding a second cost a1costP to the first parameter a1.

According to an embodiment of the present invention, the linear prediction parameter derivation section subtracts the first cost a1costN to the first parameter a1 in a case where the first parameter a1 is smaller than the predetermined threshold THN or a case where the first parameter a1 is not greater than the predetermined threshold THN.

According to an embodiment of the present invention, the linear prediction parameter derivation section adds the second cost a1costP to the first parameter a1 in a case where the first parameter a1 is larger than the predetermined threshold THP or a case where the first parameter a1 is not less than the predetermined threshold THP.

According to an embodiment of the present invention, the linear prediction parameter derivation section subtracts the first cost a1costN to the first parameter a1 in a case where the first parameter a1 is smaller than the predetermined threshold THN or a case where the first parameter a1 is not greater than the predetermined threshold THN, and the linear prediction parameter derivation section adds the second cost a1costP to the first parameter a1 in a case where the first parameter a1 is larger than the predetermined threshold THP or a case where the first parameter a1 is not less than the predetermined threshold THP.

According to an embodiment of the present invention, the linear prediction parameter derivation section further includes means for adding a cost a2cost to the second parameter a2.

According to an embodiment of the present invention, the linear prediction parameter derivation section includes at least one of means for comparing the first parameter a1 with the predetermined threshold THN and, in a case where the first parameter a1 is less than the threshold THN or not greater than the threshold THN, subtracting the first cost a1costN from the first parameter a1 and adding a cost a2costN to the second parameter a2 and means for comparing the first parameter a1 with the predetermined threshold THP and, in a case where the first parameter a1 is less than the threshold THP or not greater than the threshold THP, adding the second cost a1costP to the first parameter a1 and adding a cost a1costP to the second parameter a2.

According to an embodiment of the present invention, the linear prediction parameter derivation section includes means for subtracting the first cost a1costN to the first parameter a1 and adding the cost a2costN to the second parameter a2 in a case where the first parameter a1 is smaller than the predetermined threshold THN or a case where the first parameter a1 is not greater than the predetermined threshold THN.

According to an embodiment of the present invention, the linear prediction parameter derivation section includes means for adding the second cost a1costP to the first parameter a1 and adding the cost a1costN to the second parameter a2 in a case where the first parameter a1 is larger than the predetermined threshold THP or a case where the first parameter a1 is not less than the predetermined threshold THP.

According to an embodiment of the present invention, the cost a2cost is not less than the cost a1costN.

According to an embodiment of the present invention, the linear prediction parameter derivation section sets either or both of the thresholds THN and THP at 0.

According to an embodiment of the present invention, the linear prediction parameter derivation section derives either or both of the thresholds THN and THP on the basis of the second parameter a2.

According to an embodiment of the present invention, the linear prediction parameter derivation section sets the threshold THN at 0 and derives the threshold THP on the basis of the second parameter a2.

According to an embodiment of the present invention, the linear prediction parameter derivation section derives the threshold THN by shifting the second parameter a2 rightward by a predetermined constant.

According to an embodiment of the present invention, the linear prediction parameter derivation section derives the first cost a1costN or the second cost a1costP from the sum XX of the products of the pixel values xi and the pixel values xi.

According to an embodiment of the present invention, the linear prediction parameter derivation section derives the first cost a1costN or the second cost a1costP from the sum XY of the products of the pixel values xi and the pixel values yi.

According to an embodiment of the present invention, the linear prediction parameter derivation section derives the first cost a1costN or the second cost a1costP from bit depth values of pixels.

According to an embodiment of the present invention, the linear prediction parameter derivation section derives the first cost a1costN or the second cost a1costP on the basis of the second parameter a2.

According to an embodiment of the present invention, the linear prediction parameter derivation section derives the first cost a1costN or the second cost a1costP by shifting the second parameter a2 rightward by a predetermined constant.

According to an embodiment of the present invention, the linear prediction parameter derivation section derives the first cost a1costN or the second cost a1costP from the minimum value of a value obtained by shifting the second parameter a1 rightward by a predetermined constant and a value derived from bit depth values of pixels.

### CROSS-REFERENCE TO RELATED APPLICATIONS

The present application claims the benefit of priority to Japanese Patent Application No. 2015-197489 filed on Oct. 5, 2015, the entire contents of which are hereby incorporated by reference.

### INDUSTRIAL APPLICABILITY

The present invention is suitably applicable to an image decoding device that decodes coded data into which image data has been coded, an image encoding device which generates coded data into which image data has been coded, and a predicted image generation device that makes an inter color component prediction.

### REFERENCE SIGNS LIST

1 Image transmission system
11 Image encoding device
101 Predicted image generation section
102 Subtraction section
103 DCT and quantization section
104 Entropy coding section
105 Inverse quantization and inverse DCT section
106 Addition section
108 Prediction parameter memory (frame memory)
109 Reference picture memory (frame memory)
110 Coding parameter decision section
111 Prediction parameter coding section
112 Inter prediction parameter coding section
3036 Merge prediction parameter derivation section
3032 AMVP prediction parameter derivation section
1123 Subtraction section
1126 Prediction parameter integration section
113 Intra prediction parameter coding section
21 Network
31 Image decoding device
301 Entropy decoding section
302 Prediction parameter decoding section
303 Inter prediction parameter decoding section
30312 Merge index decoding section
30313 Vector candidate index decoding section
3032 AMVP prediction parameter derivation section
3035 Addition section
3036 Merge prediction parameter derivation section
30361 Merge candidate derivation section
303611 Merge candidate storage section
3036131 Spatial merge candidate derivation section
3036132 Temporal merge candidate derivation section
3036133 Combined merge candidate derivation section
3036134 Zero merge candidate derivation section
30362 Merge candidate selection section
304 Intra prediction parameter decoding section
306 Reference picture memory (frame memory)
307 Prediction parameter memory (frame memory)
308 Predicted image generation section
309 Inter prediction image generation section
3091 Motion compensation section
3092 Residual prediction section
3093 Illuminance compensation section
30931 Illuminance parameter estimation section
309312 Integrated value derivation section
309313 Additional value derivation section
309314 First parameter derivation section
309315 Second parameter derivation section
309316 Parameter a derivation section
3093161 First parameter normalization shift section
3093162 Second parameter normalization shift section
3093163 Table base parameter a derivation section
309317 Parameter b derivation section
309318 Regularization cost addition section
30932 Illuminance compensation filter section
3094 Weight prediction section
310 Intra prediction image generation section
3104 LM prediction section
31041, 31041A, 31041B, 31041C, 31041A2, 31041B2, 31041C2 LM parameter estimation section
31042, 31042B LM filter section
310412 LM integrated value derivation section
310413 LM additional value derivation section
310414 LM first parameter derivation section
310415 LM second parameter derivation section
310416 LM parameter a derivation section
3104161 LM first parameter normalization shift section
3104162 LM second parameter normalization shift section
3104163 LM quotient derivation section
310417 LM parameter b derivation section
310418, 310418A, 310418B, 310418C, 310418A2, 310418B2, 310418C2 LM regularization cost addition section
3104180 LM regularization cost derivation section
3104181 LM first parameter regularization cost addition section
3104182 LM second parameter regularization cost addition section
3104183 LM regularization cost threshold determination section
311 Inverse quantization and inverse DCT section
312 Addition section
41 Image display device

1. An image predicting device comprising:
a linear prediction parameter derivation circuit that, with an input being sets of pixel values xi and pixel values yi corresponding to an index i, derives linear prediction parameters a and b for predicting yi from xi; and
a linear prediction circuit that generates a predicted image on the basis of the linear prediction parameters,
wherein the linear prediction parameter derivation circuit derives a first parameter a1 on the basis of a sum XY of a products of the pixel values xi and the pixel values yi, and a product of a sum X of the pixel values xi and a sum Y of the pixel values yi, derives a second parameter a2 on the basis of a sum XX of a products of the pixel values xi, and the pixel values xi and the product of the sum X of the pixel values xi and the sum X of the pixel values xi, and derives the linear prediction parameter a by using the first parameter a1 and the second parameter a2, and
wherein the linear prediction parameter derivation circuit further includes at least one of (i) comparing the first parameter a1 with a predetermined threshold THN and, in a case where the first parameter a1 is less than or equal to the threshold THN, subtracting a first cost a1costN from the first parameter a1, or (ii) comparing the first parameter a1 with a predetermined threshold THP and, in a case where the first parameter a1 is greater than or equal to the threshold THP, adding a second cost a1costP to the first parameter a1.

2-4. (canceled)

5. The image predicting device according to claim 1, wherein the linear prediction parameter derivation circuit further adds a cost a2cost to the second parameter a2.

6. The image predicting device according to claim 1, wherein the linear prediction parameter derivation circuit includes at least one of (i) comparing the first parameter a1 with the predetermined threshold THN and, in a case where the first parameter a1 is less than or equal to the threshold THN, subtracting the first cost a1costN from the first parameter a1 and adding a third cost a2costN to the second parameter a2, or (ii) comparing the first parameter a1 with the predetermined threshold THP and, in a case where the first parameter a1 is greater than or equal to the threshold THP, adding the second cost a1costP to the first parameter a1 and adding a fourth cost a2costP to the second parameter a2.

7-8. (canceled)

9. The image predicting device according to claim 6, wherein the third cost a2costN is greater than or equal to the first cost a1costN.

10. The image predicting device according to claim 1, wherein the linear prediction parameter derivation circuit sets either or both of the thresholds THN and THP at 0.

11. The image predicting device according to claim 1, wherein the linear prediction parameter derivation circuit derives either or both of the thresholds THN and THP on the basis of the second parameter a2.

12. The image predicting device according to claim 1, wherein the linear prediction parameter derivation circuit sets the threshold THN at 0 and derives the threshold THP on the basis of the second parameter a2.

13. The image predicting device according to claim 6, wherein the linear prediction parameter derivation circuit derives the threshold THN by shifting the second parameter a2 rightward by a predetermined constant.

14. The image predicting device according to claim 1, wherein the linear prediction parameter derivation circuit derives the first cost a1costN or the second cost a1costP on the basis of the sum XX of the products of the pixel values xi and the pixel values xi.

15. The image predicting device according to claim 1, wherein the linear prediction parameter derivation circuit derives the first cost a1costN or the second cost a1costP on the basis of the sum XY of the products of the pixel values xi and the pixel values yi.

16. The image predicting device according to claim 1, wherein the linear prediction parameter derivation circuit derives the first cost a1costN or the second cost a1costP on the basis of bit depth values of pixels.

17. The image predicting device according to claim 1, wherein the linear prediction parameter derivation circuit derives the first cost a1costN or the second cost a1costP on the basis of the second parameter a2.

18. The image predicting device according to claim 1, wherein the linear prediction parameter derivation circuit derives the first cost a1costN or the second cost a1costP by shifting the second parameter a2 rightward by a predetermined constant.

19. The image predicting device according to claim 1, wherein the linear prediction parameter derivation circuit derives the first cost a1costN or the second cost a1costP on the basis of a minimum value of a value obtained by shifting the second parameter a1 rightward by a predetermined constant and a value derived from bit depth values of pixels.
